(19) United States
(12) Patent Application Publication
(10) Pub. No.: US 2020/0202243 A1
(43) Pub. Date: Jun. 25, 2020

(54) BALANCED FEDERATED LEARNING

(71) Applicant: Moshe Guttmann, Tel Aviv (IL)

(72) Inventor: Moshe Guttmann, Tel Aviv (IL)

(73) Assignee: Allegro Artificial Intelligence LTD, Ramat Gan (IL)

(21) Appl. No.: 16/808,801

(22) Filed: Mar. 4, 2020

Related U.S. Application Data
(60) Provisional application No. 62/813,827, filed on Mar. 5, 2019.

(51) Int. Cl. G06N 5/04; G06N 20/00

(52) U.S. Cl. CPC G06N 5/043; G06N 20/00

(57) ABSTRACT

Systems and methods for determining a global update to inference models using update information from a plurality of external systems are provided. A first and a second update information associated with an inference model may be received. The first update information may be based on an analysis of a first plurality of training examples by a first external system, and the second update information may be based on an analysis of a second plurality of training examples accessible by a second external system. Information related to the distribution of the first plurality of training examples and the second plurality of training examples may be obtained. The first and the second update information, and the information related to the distribution of the first plurality of training examples and the second plurality of training examples may be used to determine a global update to the inference model.

### CROSS REFERENCES TO RELATED APPLICATIONS

This application claims the benefit of priority of U.S. Provisional Patent Application No. 62/813,827, filed on Mar. 5, 2019. The entire content of all of the above-identified application is herein incorporated by reference.

### BACKGROUND

### Technological Field

The disclosed embodiments generally relate to systems and methods for federated learning. More particularly, the disclosed embodiments relate to systems and methods for balanced federated learning.

### Background Information

Computerized devices are now prevalent, and data produced and maintained by those devices is increasing.

Audio sensors are now part of numerous devices, and the availability of audio data produced by those devices is increasing.

Image sensors are now part of numerous devices, from security systems to mobile phones, and the availability of images and videos produced by those devices is increasing.

Machine learning algorithms, that use data to generate insights, rules and algorithms, are widely used.

### SUMMARY

In some embodiments, systems and methods for determining a global update to inference models using update information from a plurality of external systems are provided.

In some embodiments, a first update information associated with an inference model may be received. The first update information may be based on an analysis of a first plurality of training examples by a first external system. Information related to the distribution of the first plurality of training examples may be obtained. A second update information associated with the inference model may be received. The second update information may be based on an analysis of a second plurality of training examples accessible by a second external system. Information related to the distribution of the second plurality of training examples may be obtained. The first update information, the information related to the distribution of the first plurality of training examples, the second update information and the information related to the distribution of the second plurality of training examples may be used to determine a global update to the inference model.

In some examples, the information related to a desired distribution of the first plurality of training examples may be determined, and the information related to the desired distribution of the first plurality of training examples may be provided to the first external system to cause the first external system to select the first plurality of training examples according to the determined information related to the desired distribution of the first plurality of training examples.

In some examples, information related to a desired distribution of a third plurality of training examples may be determined based on the global update. The information related to the desired distribution of the third plurality of training examples may be provided to the first external system to cause the first external system to select the third plurality of training examples according to the determined information related to the desired distribution of the third plurality of training examples. A third update information associated with the inference model may received, the third update information may be based on an analysis of the third plurality of training examples by the first external system. Information related to the distribution of the third plurality of training examples may be obtained. A fourth update information associated with the inference model may be received. The fourth update information may be based on an analysis of a fourth plurality of training examples accessible by the second external system. Information related to the distribution of the fourth plurality of training examples may be obtained. The third update information, the information related to the distribution of the third plurality of training examples, the fourth update information and the information related to the distribution of the fourth plurality of training examples may be used to determine a second global update to the inference model.

In some examples, the first plurality of training examples may be accessible by the first external system and not accessible by the second external system, and in some examples the second plurality of training examples may be accessible by the second external system and not accessible by the first external system. In some examples, the first update information may be received from the first external system, and in some examples the second update information may be received from the second external system. In some examples, information related to the distribution of the first plurality of training examples may be received from the first external system, and in some examples the information related to the distribution of the second plurality of training examples may be received from the second external system.

In some examples, the information related to the distribution of the first plurality of training examples may be used to determine a weight for the first update information, and the information related to the distribution of the second plurality of training examples may be used to determine a weight for the second update information. The first update information, the weight for the first update information, the second update information and the weight for the second update information may be used to determine the global update to the inference model.

In some examples, the information related to the distribution of the first plurality of training examples and the information related to the distribution of the second plurality of training examples may be used to determine a weight for the first update information and a weight for the second update information. The first update information, the weight for the first update information, the second update information and the weight for the second update information may be used to determine the global update to the inference model.

In some examples, the global update may be provided to the first external system and/or to the second external system. In some examples, the global update may be used to update the inference model and obtain an updated inference model. In some examples, the updated inference model may be provided to the first external system and/or to the second external system.

In some examples, the first update information may be insufficient to reconstruct any training example of the first plurality of training examples. In some examples, the first update information may be insufficient to reconstruct at least one training example of the first plurality of training examples.

In some examples, the first update information may comprise at least a direction of at least a portion of a first gradient determined using the first plurality of training examples, and the second update information may comprise at least a direction of at least a portion of a second gradient determined using the second plurality of training examples.

In some examples, the information related to the distribution of the first plurality of training examples and the information related to the distribution of the second plurality of training examples may be used to calculate an aggregate of the direction of the at least a portion of the first gradient determined using the first plurality of training examples and the direction of at least a portion of a second gradient determined using the second plurality of training examples. The calculated aggregate may be used to determine the global update to the inference model.

In some examples, first update information may comprise at least a magnitude of at least a portion of a first gradient determined using the first plurality of training examples, and the second update information may comprise at least a magnitude of at least a portion of a second gradient determined using the second plurality of training examples. In some examples, the information related to the distribution of the first plurality of training examples and the information related to the distribution of the second plurality of training examples may be used to calculate an aggregate of the magnitude of the at least a portion of the first gradient determined using the first plurality of training examples and the magnitude of at least a portion of a second gradient determined using the second plurality of training examples. The calculated aggregate may be used to determine the global update to the inference model.

In some examples, the information related to the distribution of the first plurality of training examples and/or the information related to the distribution of the second plurality of training examples may be used to select one of the first update information and the second update information. The selected one of the first update information and the second update information may be used to determine the global update to the inference model.

In some examples, the global update to the inference model may be determined based on a gradient descent update of the inference model.

In some examples, the inference model may include at least one of an artificial neural network, a classifier and a regression model.

In some examples, the distribution of the first plurality of training examples may differ from the distribution of the second plurality of training examples.

Consistent with other disclosed embodiments, non-transitory computer-readable storage media may store data and/or computer implementable instructions for carrying out any of the methods described herein.

### BRIEF DESCRIPTION OF THE DRAWINGS

FIGS. 1A and 1B are block diagrams illustrating some possible implementations of a communicating system.

FIGS. 2A and 2B are block diagrams illustrating some possible implementations of an apparatus.

FIG. 3 is a block diagram illustrating a possible implementation of a server.

FIGS. 4A and 4B are block diagrams illustrating some possible implementations of a cloud platform.

FIG. 5 is a block diagram illustrating a possible implementation of a computational node.

FIG. 6 illustrates an exemplary embodiment of a memory storing a plurality of modules.

FIG. 7 illustrates an example of a method for determining a global update to inference models using update information from a plurality of external systems.

FIG. 8 illustrates an example of a method for determining a global update to inference models using update information from a plurality of external systems.

### DESCRIPTION

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, “monitoring”, “providing”, “identifying”, “segmenting”, “classifying”, “analyzing”, “associating”, “extracting”, “storing”, “receiving”, “transmitting”, or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, “computing unit”, and “processing module” should be expansively construed to cover any kind of electronic device, component or unit with data processing capabilities, including, by way of non-limiting example, a personal computer, a wearable computer, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a single core processor, a multi core processor, a core within a processor, any other electronic computing device, or any combination of the above.

The operations in accordance with the teachings herein may be performed by a computer specially constructed or programmed to perform the described functions.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) may be included in at least one embodiment of the presently disclosed subject matter. Thus the appearance of the phrase “one case”, “some cases”, “other cases” or variants thereof does not necessarily refer to the same embodiment(s). As used herein, the term “and/or” includes any and all combinations of one or more of the associated listed items.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

The term “image sensor” is recognized by those skilled in the art and refers to any device configured to capture images, a sequence of images, videos, and so forth. This includes sensors that convert optical input into images, where optical input can be visible light (like in a camera), radio waves, microwaves, terahertz waves, ultraviolet light, infrared light, x-rays, gamma rays, and/or any other light spectrum. This also includes both 2D and 3D sensors. Examples of image sensor technologies may include: CCD, CMOS, NMOS, and so forth. 3D sensors may be implemented using different technologies, including: stereo camera, active stereo camera, time of flight camera, structured light camera, radar, range image camera, and so forth.

The term “audio sensor” is recognized by those skilled in the art and refers to any device configured to capture audio data. This includes sensors that convert audio and sounds into digital audio data.

The term “electrical impedance sensor” is recognized by those skilled in the art and refers to any sensor configured to measure the electrical connectivity and/or permittivity between two or more points. This include but not limited to: sensors configured to measuring changes in connectivity and/or permittivity over time; sensors configured to measure the connectivity and/or permittivity of biological tissues; sensors configured to measure the connectivity and/or permittivity of parts of body based, at least in part, on the connectivity and/or permittivity between surface electrodes; sensors configured to provide Electrical Impedance Tomography images, and so forth. Such sensors may include but not limited to: sensors that apply alternating currents at a single frequency; sensors that apply alternating currents at multiple frequencies; and so forth. Additionally, this may also include sensors that measure the electrical resistance between two or more points, which are sometimes referred to as ohmmeter.

In embodiments of the presently disclosed subject matter, one or more stages illustrated in the figures may be executed in a different order and/or one or more groups of stages may be executed simultaneously and vice versa. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

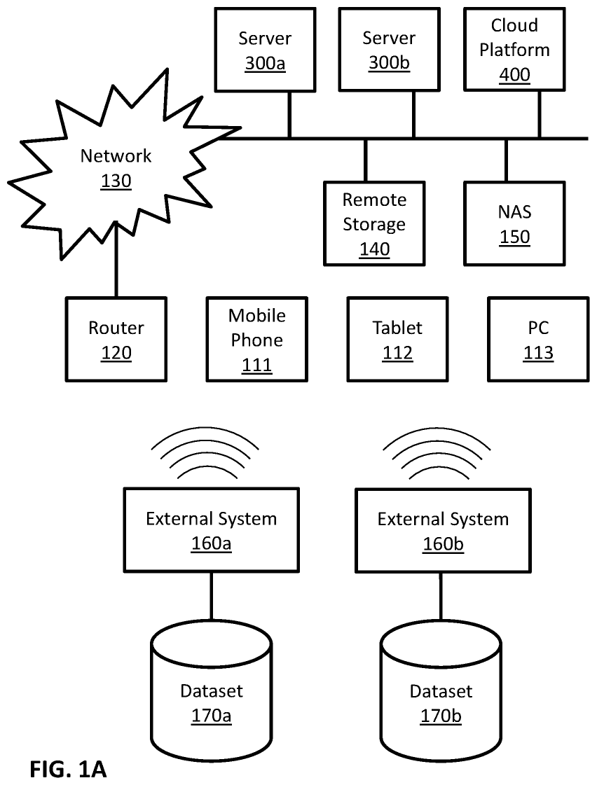

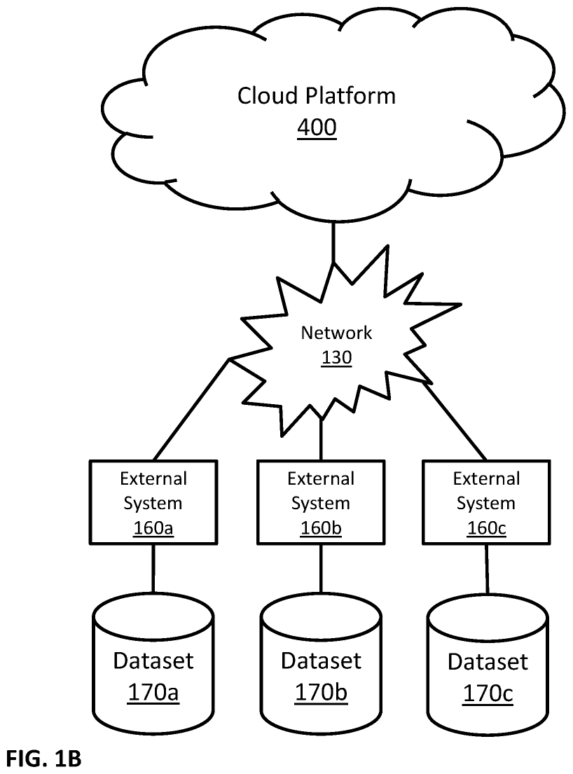

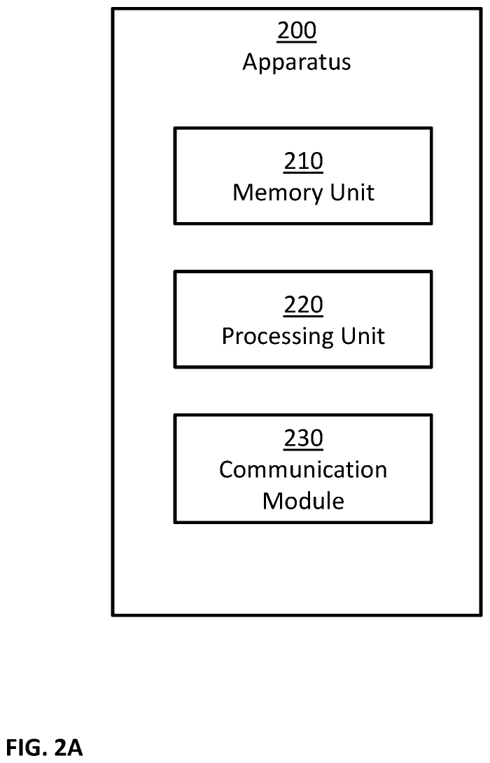

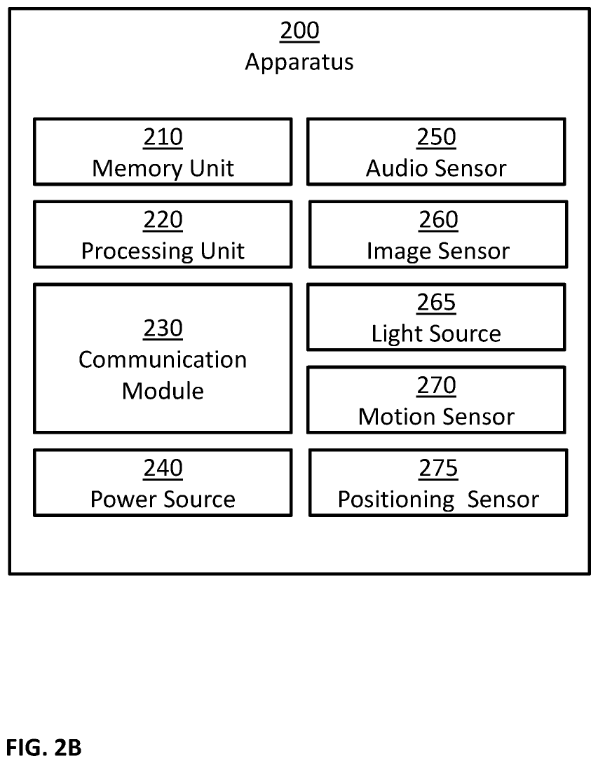

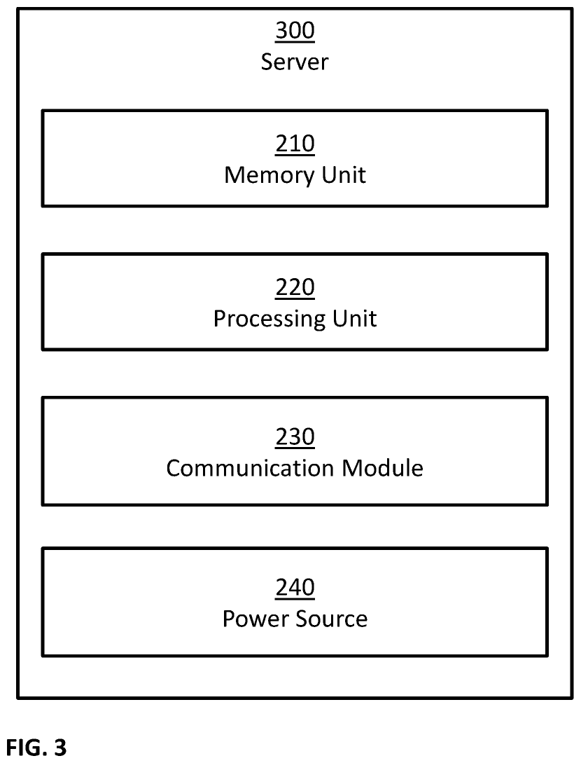

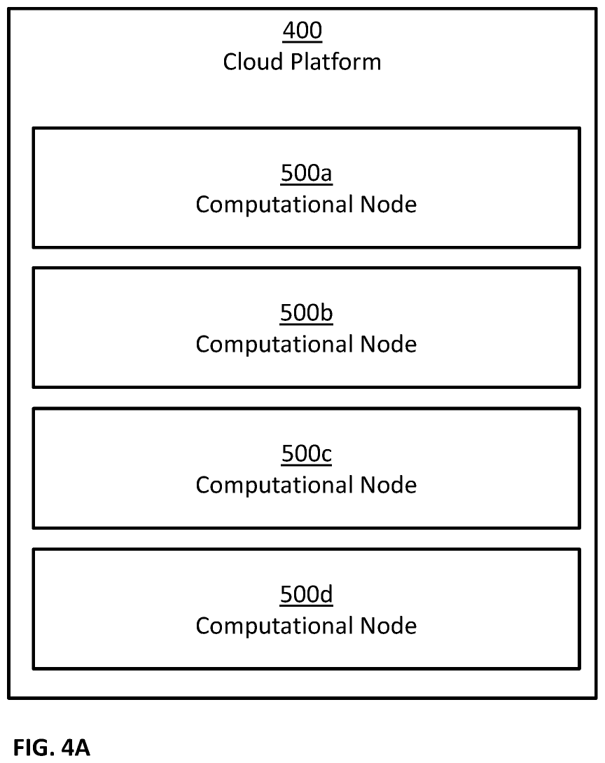

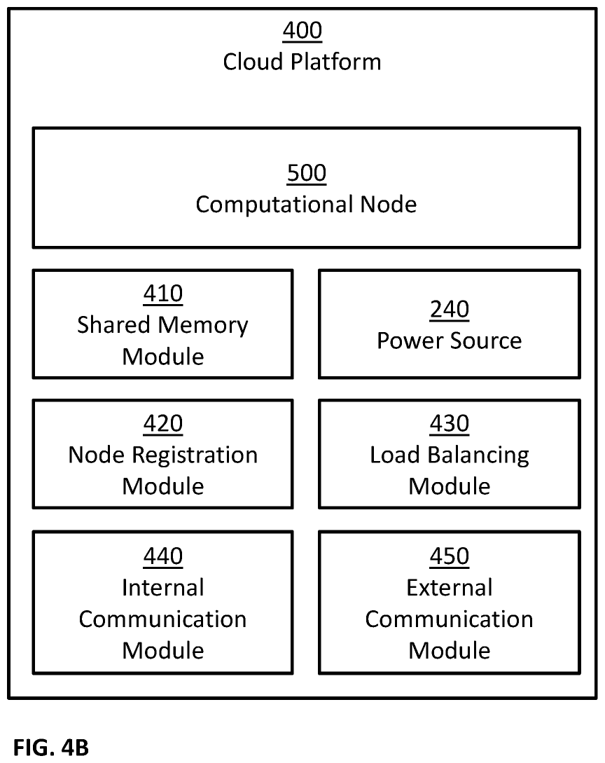

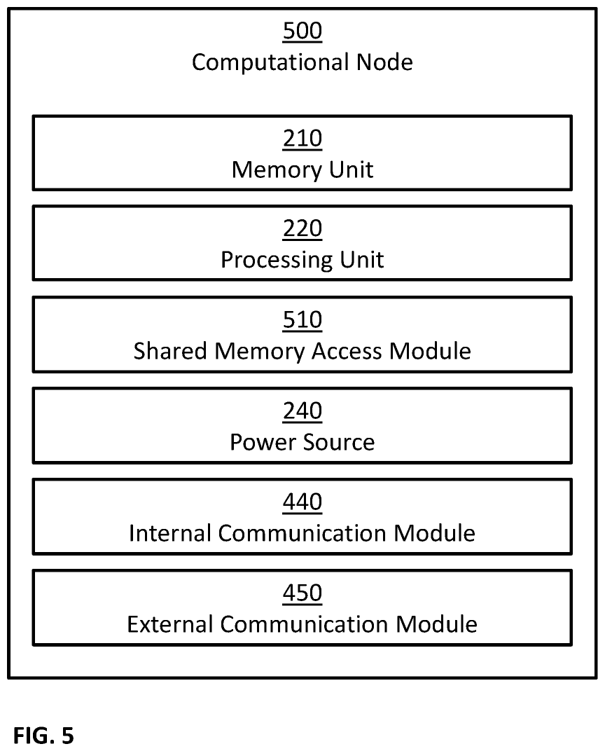

FIG. 1A is a block diagram illustrating a possible implementation of a communicating system. In this example, external systems 160a and 160b may communicate with server 300a, with server 300b, with cloud platform 400, with each other, and so forth. Some non-limiting examples of possible implementations of external systems 160a and 160b may include apparatus 200 as described in FIGS. 2A and 2B, server 300 as described in FIG. 3, cloud platform 400 are described in FIGS. 4A, 4B and 5, a mobile phone, a tablet, a Personal Computer (PC), a computerized device, and so forth. Possible implementations of servers 300a and 300b may include server 300 as described in FIG. 3. Some possible implementations of cloud platform 400 are described in FIGS. 4A, 4B and 5. In this example external systems 160a and 160b may communicate directly with mobile phone 111, tablet 112, and personal computer (PC) 113. External systems 160a and 160b may communicate with local router 120 directly, and/or through at least one of mobile phone 111, tablet 112, and personal computer (PC) 113. In this example, local router 120 may be connected with a communication network 130. Examples of communication network 130 may include the Internet, phone networks, cellular networks, satellite communication networks, private communication networks, virtual private networks (VPN), and so forth. External systems 160a and 160b may connect to communication network 130 through local router 120 and/or directly. External systems 160a and 160b may communicate with other devices, such as servers 300a, server 300b, cloud platform 400, remote storage 140 and network attached storage (NAS) 150, through communication network 130 and/or directly. In this example, external system 160a may have access to dataset 170a, and external system 160b may have access to dataset 170b. In one example, external system 160a may have no access to dataset 170b, and external system 160b may have no access to dataset 170a. In some examples, one or more of mobile phone 111, tablet 112, personal computer (PC) 113, server 300a, server 300b and cloud platform 400 may have no access to dataset 170a and/or to dataset 170b.

FIG. 1B is a block diagram illustrating a possible implementation of a communicating system. In this example, external systems 160a, 160b and 160c may communicate with cloud platform 400 and/or with each other through communication network 130. Some non-limiting examples of possible implementations of external systems 160a, 160b and 160c may include apparatus 200 as described in FIGS. 2A and 2B, server 300 as described in FIG. 3, cloud platform 400 are described in FIGS. 4A, 4B and 5, a mobile phone, a tablet, a Personal Computer (PC), a computerized device, and so forth. Some possible implementations of cloud platform 400 are described in FIGS. 4A, 4B and 5. In this example, external system 160a may have access to dataset 170a, external system 160b may have access to dataset 170b, and external system 160c may have access to dataset 170c. In one example, external system 160a may have no access to dataset 170b and/or to dataset 170c, external system 160b may have no access to dataset 170a and/or to dataset 170c, and external system 160c may have no access to dataset 170a and/or to dataset 170b. In some examples, cloud platform 400 may have no access to dataset 170a and/or to dataset 170b and/or to dataset 170c.

In some examples, each one of dataset 170a, 170b and dataset 170c may include information configured to be used for training a machine learning model. For example, each one of dataset 170a, 170b and dataset 170c may include at least one of a training set comprising a plurality of training examples, a validation set comprising a plurality of validation examples, and a test set comprising a plurality of test examples. In another example, each one of dataset 170a, 170b and dataset 170c may include information as described below in relation to dataset 610.

FIGS. 1A and 1B illustrate some possible implementations of a communication system. In some embodiments, other communication systems that enable communication between external systems 160 and server 300 may be used. In some embodiments, other communication systems that enable communication between external systems 160 and cloud platform 400 may be used. In some embodiments, other communication systems that enable communication among a plurality of external systems 160 may be used.

FIG. 2A is a block diagram illustrating a possible implementation of apparatus 200. In this example, apparatus 200 may comprise: one or more memory units 210, one or more processing units 220, and one or more communication modules 230. In some implementations, apparatus 200 may comprise additional components, while some components listed above may be excluded.

FIG. 2B is a block diagram illustrating a possible implementation of apparatus 200. In this example, apparatus 200 may comprise: one or more memory units 210, one or more processing units 220, one or more communication modules 230, one or more power sources 240, one or more audio sensors 250, one or more image sensors 260, one or more light sources 265, one or more motion sensors 270, and one or more positioning sensors 275. In some implementations, apparatus 200 may comprise additional components, while some components listed above may be excluded. For example, in some implementations apparatus 200 may also comprise at least one of the following: one or more barometers; one or more pressure sensors; one or more proximity sensors; one or more electrical impedance sensors; one or more electrical voltage sensors; one or more electrical current sensors; one or more user input devices; one or more output devices; and so forth. In another example, in some implementations at least one of the following may be excluded from apparatus 200: memory units 210, communication modules 230, power sources 240, audio sensors 250, image sensors 260, light sources 265, motion sensors 270, and positioning sensors 275.

In some embodiments, one or more power sources 240 may be configured to: power apparatus 200; power server 300; power cloud platform 400; and/or power computational node 500. Possible implementation examples of power sources 240 may include: one or more electric batteries; one or more capacitors; one or more connections to external power sources; one or more power convertors; any combination of the above; and so forth.

In some embodiments, the one or more processing units 220 may be configured to execute software programs. For example, processing units 220 may be configured to execute software programs stored on the memory units 210. In some cases, the executed software programs may store information in memory units 210. In some cases, the executed software programs may retrieve information from the memory units 210. Possible implementation examples of the processing units 220 may include: one or more single core processors, one or more multicore processors; one or more controllers; one or more application processors; one or more system on a chip processors; one or more central processing units; one or more graphical processing units; one or more neural processing units; any combination of the above; and so forth.

In some embodiments, the one or more communication modules 230 may be configured to receive and transmit information. For example, control signals may be transmitted and/or received through communication modules 230. In another example, information received though communication modules 230 may be stored in memory units 210. In an additional example, information retrieved from memory units 210 may be transmitted using communication modules 230. In another example, input data may be transmitted and/or received using communication modules 230. Examples of such input data may include: input data inputted by a user using user input devices; information captured using one or more sensors; and so forth. Examples of such sensors may include: audio sensors 250; image sensors 260; motion sensors 270; positioning sensors 275; chemical sensors; temperature sensors; barometers; pressure sensors; proximity sensors; electrical impedance sensors; electrical voltage sensors; electrical current sensors; and so forth.

In some embodiments, the one or more audio sensors 250 may be configured to capture audio by converting sounds to digital information. Some examples of audio sensors 250 may include: microphones, unidirectional microphones, bidirectional microphones, cardioid microphones, omnidirectional microphones, onboard microphones, wired microphones, wireless microphones, any combination of the above, and so forth. In some examples, the captured audio may be stored in memory units 210. In some additional examples, the captured audio may be transmitted using communication modules 230, for example to other computerized devices, such as server 300, cloud platform 400, computational node 500, and so forth. In some examples, processing units 220 may control the above processes. For example, processing units 220 may control at least one of: capturing of the audio; storing the captured audio; transmitting of the captured audio; and so forth. In some cases, the captured audio may be processed by processing units 220. For example, the captured audio may be compressed by processing units 220; possibly followed: by storing the compressed captured audio in memory units 210; by transmitted the compressed captured audio using communication modules 230; and so forth. In another example, the captured audio may be processed using speech recognition algorithms. In another example, the captured audio may be processed using speaker recognition algorithms.

In some embodiments, the one or more image sensors 260 may be configured to capture visual information by converting light to: images; sequence of images; videos; and so forth. In some examples, the captured visual information may be stored in memory units 210. In some additional examples, the captured visual information may be transmitted using communication modules 230, for example to other computerized devices, such as server 300, cloud platform 400, computational node 500, and so forth. In some examples, processing units 220 may control the above processes. For example, processing units 220 may control at least one of: capturing of the visual information; storing the captured visual information; transmitting the captured visual information; and so forth. In some cases, the captured visual information may be processed by processing units 220. For example, the captured visual information may be compressed by processing units 220; possibly followed: by storing the compressed captured visual information in memory units 210; by transmitted the compressed captured visual information using communication modules 230; and so forth. In another example, the captured visual information may be processed in order to: detect objects, detect events, detect action, detect face, detect people, recognize person, and so forth.

In some embodiments, the one or more light sources 265 may be configured to emit light, for example in order to enable better image capturing by image sensors 260. In some examples, the emission of light may be coordinated with the capturing operation of image sensors 260. In some examples, the emission of light may be continuous. In some examples, the emission of light may be performed at selected times. The emitted light may be visible light, infrared light, x-rays, gamma rays, and/or in any other light spectrum.

In some embodiments, the one or more motion sensors 270 may be configured to perform at least one of the following: detect motion of objects in the environment of apparatus 200; measure the velocity of objects in the environment of apparatus 200; measure the acceleration of objects in the environment of apparatus 200; detect motion of apparatus 200; measure the velocity of apparatus 200; measure the acceleration of apparatus 200; and so forth. In some implementations, the one or more motion sensors 270 may comprise one or more accelerometers configured to detect changes in proper acceleration and/or to measure proper acceleration of apparatus 200. In some implementations, the one or more motion sensors 270 may comprise one or more gyroscopes configured to detect changes in the orientation of apparatus 200 and/or to measure information related to the orientation of apparatus 200. In some implementations, motion sensors 270 may be implemented using image sensors 260, for example by analyzing images captured by image sensors 260 to perform at least one of the following tasks: track objects in the environment of apparatus 200; detect moving objects in the environment of apparatus 200; measure the velocity of objects in the environment of apparatus 200; measure the acceleration of objects in the environment of apparatus 200; measure the velocity of apparatus 200, for example by calculating the egomotion of image sensors 260; measure the acceleration of apparatus 200, for example by calculating the egomotion of image sensors 260; and so forth. In some implementations, motion sensors 270 may be implemented using image sensors 260 and light sources 265, for example by implementing a LIDAR using image sensors 260 and light sources 265. In some implementations, motion sensors 270 may be implemented using one or more RADARs. In some examples, information captured using motion sensors 270: may be stored in memory units 210, may be processed by processing units 220, may be transmitted and/or received using communication modules 230, and so forth.

In some embodiments, the one or more positioning sensors 275 may be configured to obtain positioning information of apparatus 200, to detect changes in the position of apparatus 200, and/or to measure the position of apparatus 200. In some examples, positioning sensors 275 may be implemented using one of the following technologies: Global Positioning System (GPS), GLObal NAvigation Satellite System (GLONASS), Galileo global navigation system, BeiDou navigation system, other Global Navigation Satellite Systems (GNSS), Indian Regional Navigation Satellite System (IRNSS), Local Positioning Systems (LPS), Real-Time Location Systems (RTLS), Indoor Positioning System (IPS), Wi-Fi based positioning systems, cellular triangulation, and so forth. In some examples, information captured using positioning sensors 275 may be stored in memory units 210, may be processed by processing units 220, may be transmitted and/or received using communication modules 230, and so forth.

In some embodiments, the one or more chemical sensors may be configured to perform at least one of the following: measure chemical properties in the environment of apparatus 200; measure changes in the chemical properties in the environment of apparatus 200; detect the present of chemicals in the environment of apparatus 200; measure the concentration of chemicals in the environment of apparatus 200. Examples of such chemical properties may include: pH level, toxicity, temperature, and so forth. Examples of such chemicals may include: electrolytes, particular enzymes, particular hormones, particular proteins, smoke, carbon dioxide, carbon monoxide, oxygen, ozone, hydrogen, hydrogen sulfide, and so forth. In some examples, information captured using chemical sensors may be stored in memory units 210, may be processed by processing units 220, may be transmitted and/or received using communication modules 230, and so forth.

In some embodiments, the one or more temperature sensors may be configured to detect changes in the temperature of the environment of apparatus 200 and/or to measure the temperature of the environment of apparatus 200. In some examples, information captured using temperature sensors may be stored in memory units 210, may be processed by processing units 220, may be transmitted and/or received using communication modules 230, and so forth.

In some embodiments, the one or more barometers may be configured to detect changes in the atmospheric pressure in the environment of apparatus 200 and/or to measure the atmospheric pressure in the environment of apparatus 200. In some examples, information captured using the barometers may be stored in memory units 210, may be processed by processing units 220, may be transmitted and/or received using communication modules 230, and so forth.

In some embodiments, the one or more pressure sensors may be configured to perform at least one of the following: detect pressure in the environment of apparatus 200; measure pressure in the environment of apparatus 200; detect change in the pressure in the environment of apparatus 200; measure change in pressure in the environment of apparatus 200; detect pressure at a specific point and/or region of the surface area of apparatus 200; measure pressure at a specific point and/or region of the surface area of apparatus 200; detect change in pressure at a specific point and/or area; measure change in pressure at a specific point and/or region of the surface area of apparatus 200; measure the pressure differences between two specific points and/or regions of the surface area of apparatus 200; measure changes in relative pressure between two specific points and/or regions of the surface area of apparatus 200. In some examples, information captured using the pressure sensors may be stored in memory units 210, may be processed by processing units 220, may be transmitted and/or received using communication modules 230, and so forth.

In some embodiments, the one or more proximity sensors may be configured to perform at least one of the following: detect contact of a solid object with the surface of apparatus 200; detect contact of a solid object with a specific point and/or region of the surface area of apparatus 200; detect a proximity of apparatus 200 to an object. In some implementations, proximity sensors may be implemented using image sensors 260 and light sources 265, for example by emitting light using light sources 265, such as ultraviolet light, visible light, infrared light and/or microwave light, and detecting the light reflected from nearby objects using image sensors 260 to detect the present of nearby objects. In some examples, information captured using the proximity sensors may be stored in memory units 210, may be processed by processing units 220, may be transmitted and/or received using communication modules 230, and so forth.

In some embodiments, the one or more electrical impedance sensors may be configured to perform at least one of the following: detect change over time in the connectivity and/or permittivity between two electrodes; measure changes over time in the connectivity and/or permittivity between two electrodes; capture Electrical Impedance Tomography (EIT) images. In some examples, information captured using the electrical impedance sensors may be stored in memory units 210, may be processed by processing units 220, may be transmitted and/or received using communication modules 230, and so forth.

In some embodiments, the one or more electrical voltage sensors may be configured to perform at least one of the following: detect and/or measure voltage between two electrodes; detect and/or measure changes over time in the voltage between two electrodes. In some examples, information captured using the electrical voltage sensors may be stored in memory units 210, may be processed by processing units 220, may be transmitted and/or received using communication modules 230, and so forth.

In some embodiments, the one or more electrical current sensors may be configured to perform at least one of the following: detect and/or measure electrical current flowing between two electrodes; detect and/or measure changes over time in the electrical current flowing between two electrodes. In some examples, information captured using the electrical current sensors may be stored in memory units 210, may be processed by processing units 220, may be transmitted and/or received using communication modules 230, and so forth.

In some embodiments, the one or more user input devices may be configured to allow one or more users to input information. In some examples, user input devices may comprise at least one of the following: a keyboard, a mouse, a touch pad, a touch screen, a joystick, a microphone, an image sensor, and so forth. In some examples, the user input may be in the form of at least one of: text, sounds, speech, hand gestures, body gestures, tactile information, and so forth. In some examples, the user input may be stored in memory units 210, may be processed by processing units 220, may be transmitted and/or received using communication modules 230, and so forth.

In some embodiments, the one or more user output devices may be configured to provide output information to one or more users. In some examples, such output information may comprise of at least one of: notifications, feedbacks, reports, and so forth. In some examples, user output devices may comprise at least one of: one or more audio output devices; one or more textual output devices; one or more visual output devices; one or more tactile output devices; and so forth. In some examples, the one or more audio output devices may be configured to output audio to a user, for example through: a headset, a set of speakers, and so forth. In some examples, the one or more visual output devices may be configured to output visual information to a user, for example through: a display screen, an augmented reality display system, a printer, a LED indicator, and so forth. In some examples, the one or more tactile output devices may be configured to output tactile feedbacks to a user, for example through vibrations, through motions, by applying forces, and so forth. In some examples, the output may be provided: in real time, offline, automatically, upon request, and so forth. In some examples, the output information may be read from memory units 210, may be provided by a software executed by processing units 220, may be transmitted and/or received using communication modules 230, and so forth.

FIG. 3 is a block diagram illustrating a possible implementation of server 300. In this example, server 300 may comprise: one or more memory units 210, one or more processing units 220, one or more communication modules 230, and one or more power sources 240. In some implementations, server 300 may comprise additional components, while some components listed above may be excluded. For example, in some implementations server 300 may also comprise at least one of the following: one or more user input devices; one or more output devices; and so forth. In another example, in some implementations at least one of the following may be excluded from server 300: memory units 210, communication modules 230, and power sources 240.

FIG. 4A is a block diagram illustrating a possible implementation of cloud platform 400. In this example, cloud platform 400 may comprise computational node 500a, computational node 500b, computational node 500c and computational node 500d. In some examples, a possible implementation of computational nodes 500a, 500b, 500c and 500d may comprise server 300 as described in FIG. 3. In some examples, a possible implementation of computational nodes 500a, 500b, 500c and 500d may comprise computational node 500 as described in FIG. 5.

FIG. 4B is a block diagram illustrating a possible implementation of cloud platform 400. In this example, cloud platform 400 may comprise: one or more computational nodes 500, one or more shared memory modules 410, one or more power sources 240, one or more node registration modules 420, one or more load balancing modules 430, one or more internal communication modules 440, and one or more external communication modules 450. In some implementations, cloud platform 400 may comprise additional components, while some components listed above may be excluded. For example, in some implementations cloud platform 400 may also comprise at least one of the following: one or more user input devices; one or more output devices; and so forth. In another example, in some implementations at least one of the following may be excluded from cloud platform 400: shared memory modules 410, power sources 240, node registration modules 420, load balancing modules 430, internal communication modules 440, and external communication modules 450.

FIG. 5 is a block diagram illustrating a possible implementation of computational node 500. In this example, computational node 500 may comprise: one or more memory units 210, one or more processing units 220, one or more shared memory access modules 510, one or more power sources 240, one or more internal communication modules 440, and one or more external communication modules 450. In some implementations, computational node 500 may comprise additional components, while some components listed above may be excluded. For example, in some implementations computational node 500 may also comprise at least one of the following: one or more user input devices; one or more output devices; and so forth. In another example, in some implementations at least one of the following may be excluded from computational node 500: memory units 210, shared memory access modules 510, power sources 240, internal communication modules 440, and external communication modules 450.

In some embodiments, internal communication modules 440 and external communication modules 450 may be implemented as a combined communication module, such as communication modules 230. In some embodiments, one possible implementation of cloud platform 400 may comprise server 300. In some embodiments, one possible implementation of computational node 500 may comprise server 300. In some embodiments, one possible implementation of shared memory access modules 510 may comprise using internal communication modules 440 to send information to shared memory modules 410 and/or receive information from shared memory modules 410. In some embodiments, node registration modules 420 and load balancing modules 430 may be implemented as a combined module.

In some embodiments, the one or more shared memory modules 410 may be accessed by more than one computational node. Therefore, shared memory modules 410 may allow information sharing among two or more computational nodes 500. In some embodiments, the one or more shared memory access modules 510 may be configured to enable access of computational nodes 500 and/or the one or more processing units 220 of computational nodes 500 to shared memory modules 410. In some examples, computational nodes 500 and/or the one or more processing units 220 of computational nodes 500, may access shared memory modules 410, for example using shared memory access modules 510, in order to perform at least one of: executing software programs stored on shared memory modules 410, store information in shared memory modules 410, retrieve information from the shared memory modules 410.

In some embodiments, the one or more node registration modules 420 may be configured to track the availability of the computational nodes 500. In some examples, node registration modules 420 may be implemented as: a software program, such as a software program executed by one or more of the computational nodes 500; a hardware solution; a combined software and hardware solution; and so forth. In some implementations, node registration modules 420 may communicate with computational nodes 500, for example using internal communication modules 440. In some examples, computational nodes 500 may notify node registration modules 420 of their status, for example by sending messages: at computational node 500 startup; at computational node 500 shutdowns; at constant intervals; at selected times; in response to queries received from node registration modules 420; and so forth. In some examples, node registration modules 420 may query about computational nodes 500 status, for example by sending messages: at node registration module 420 startup; at constant intervals; at selected times; and so forth.

In some embodiments, the one or more load balancing modules 430 may be configured to divide the work load among computational nodes 500. In some examples, load balancing modules 430 may be implemented as: a software program, such as a software program executed by one or more of the computational nodes 500; a hardware solution; a combined software and hardware solution; and so forth. In some implementations, load balancing modules 430 may interact with node registration modules 420 in order to obtain information regarding the availability of the computational nodes 500. In some implementations, load balancing modules 430 may communicate with computational nodes 500, for example using internal communication modules 440. In some examples, computational nodes 500 may notify load balancing modules 430 of their status, for example by sending messages: at computational node 500 startup; at computational node 500 shutdowns; at constant intervals; at selected times; in response to queries received from load balancing modules 430; and so forth. In some examples, load balancing modules 430 may query about computational nodes 500 status, for example by sending messages: at load balancing module 430 startup; at constant intervals; at selected times; and so forth.

In some embodiments, the one or more internal communication modules 440 may be configured to receive information from one or more components of cloud platform 400, and/or to transmit information to one or more components of cloud platform 400. For example, control signals and/or synchronization signals may be sent and/or received through internal communication modules 440. In another example, input information for computer programs, output information of computer programs, and/or intermediate information of computer programs, may be sent and/or received through internal communication modules 440. In another example, information received though internal communication modules 440 may be stored in memory units 210, in shared memory units 410, and so forth. In an additional example, information retrieved from memory units 210 and/or shared memory units 410 may be transmitted using internal communication modules 440. In another example, input data may be transmitted and/or received using internal communication modules 440. Examples of such input data may include input data inputted by a user using user input devices.

In some embodiments, the one or more external communication modules 450 may be configured to receive and/or to transmit information. For example, control signals may be sent and/or received through external communication modules 450. In another example, information received though external communication modules 450 may be stored in memory units 210, in shared memory units 410, and so forth. In an additional example, information retrieved from memory units 210 and/or shared memory units 410 may be transmitted using external communication modules 450. In another example, input data may be transmitted and/or received using external communication modules 450. Examples of such input data may include: input data inputted by a user using user input devices; information captured from the environment of apparatus 200 using one or more sensors; and so forth. Examples of such sensors may include: audio sensors 250; image sensors 260; motion sensors 270; positioning sensors 275; chemical sensors; temperature sensors; barometers; pressure sensors; proximity sensors; electrical impedance sensors; electrical voltage sensors; electrical current sensors; and so forth.

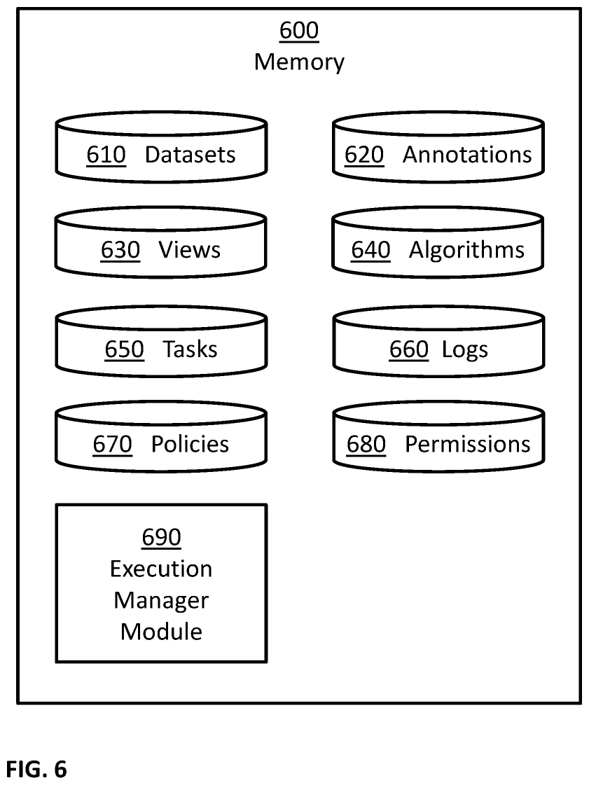

FIG. 6 illustrates an exemplary embodiment of memory 600 storing a plurality of modules. In some examples, memory 600 may be separate from and/or integrated with memory units 210, separate from and/or integrated with memory units 410, and so forth. In some examples, memory 600 may be included in a single device, for example in apparatus 200, in server 300, in cloud platform 400, in computational node 500, and so forth. In some examples, memory 600 may be distributed across several devices. Memory 600 may store more or fewer modules than those shown in FIG. 6. In this example, memory 600 may comprise: one or more datasets 610, one or more annotations 620, one or more views 630, one or more algorithms 640, one or more tasks 650, one or more logs 660, one or more policies 670, one or more permissions 680, and an execution manager module 690. Execution manager module 690 may be implemented in software, hardware, firmware, a mix of any of those, or the like. For example, if the modules are implemented in software, they may contain software instructions for execution by at least one processing device, such as processing unit 220, by apparatus 200, by server 300, by cloud platform 400, by computational node 500, and so forth. In some examples, execution manager module 690 may be configured to perform at least one of processes 700 and 800, and so forth.

In some embodiments, dataset 610 may comprise data and information. For example, dataset 610 may comprise information pertinent to a subject, an issue, a topic, a problem, a task, and so forth. In some embodiments, dataset 610 may comprise one or more tables, such as database tables, spreadsheets, matrixes, and so forth. In some examples, dataset 610 may comprise one or more n-dimensional tables, such as tensors. In some embodiments, dataset 610 may comprise information about relations among items, for example in a form of graphs, hyper-graphs, lists of connections, matrices holding similarities, n-dimensional tables holding similarities, matrices holding distances, n-dimensional tables holding dissimilarities, and so forth. In some embodiments, dataset 610 may comprise hierarchical information, for example in the form a tree, hierarchical database, and so forth. In some embodiments, dataset 610 may comprise textual information, for example in the form of strings of characters, textual documents, documents in a markup language (such as HTML and XML), and so forth. In some embodiments, dataset 610 may comprise visual information, such as images, videos, graphical content, and so forth. In some embodiments, dataset 610 may comprise audio data, such as sound recordings, audio recordings, synthesized audio, and so forth.

In some embodiments, dataset 610 may comprise sensor readings, such as audio captured using audio sensors 250, images captured using image sensors 260, motion information captured using motion sensors 270, positioning information captured using positioning sensors 275, atmospheric pressure information captured using barometers, pressure information captured using pressure sensors, proximity information captured using proximity sensors, electrical impedance information captured using electrical impedance sensors, electrical voltage information captured using electrical voltage sensors, electrical current information captured using electrical current sensors, user input obtained using user input devices, and so forth.

In some embodiments, dataset 610 may comprise data and information arranged in data-points. For example, a data-point may correspond to an individual, to an object, to a geographical location, to a geographical region, to a species, and so forth. For example, dataset 610 may comprise a table, and each row or slice may represent a data-point. For example, dataset 610 may comprise several tables, and each data-point may correspond to entries in one or more tables. For example, a data-point may comprise a text document, a portion of a text document, a corpus of text documents, and so forth. For example, a data-point may comprise an image, a portion of an image, a video clip, a portion of a video clip, a group of images, a group of video clips, a time span within a video recording, a sound recording, a time span within a sound recording, and so forth. For example, a data-point may comprise to a group of sensor readings. In some examples, dataset 610 may further comprise information about relations among data-points, for example a data-point may correspond to a node in a graph or in a hypergraph, and an edge or a hyperedge may correspond to a relation among data-points and may be labeled with properties of the relation. In some examples, data-points may be arranged in hierarchies, for example a data-point may correspond to a node in a tree.

In some embodiments, a dataset 610 may be produced and/or maintain by a single user, by multiple users collaborating to produce and/or maintain dataset 610, by an automatic process, by multiple automatic processes collaborating to produce and/or maintain dataset 610, by one or more users and one or more automatic processes collaborating to produce and/or maintain dataset 610, and so forth. In some examples, a user and/or an automatic process may produce and/or maintain no dataset 610, a single dataset 610, multiple datasets 610, and so forth.

In some embodiments, annotations 620 may comprise information related to datasets 610 and/or to elements within datasets 610. In some examples, a single annotation 620 may comprise information related to one dataset or to multiple datasets, and a single dataset 610 may have no, a single, or multiple annotations related to it. For example, dataset 610 may have multiple annotations 620 that complement each other, multiple annotations 620 that are inconsistent or contradict each other, and so forth.

In some embodiments, annotation 620 may be produced and/or maintain by a single user, by multiple users collaborating to produce and/or maintain annotation 620, by an automatic process, by multiple automatic processes collaborating to produce and/or maintain annotation 620, by one or more users and one or more automatic processes collaborating to produce and/or maintain annotation 620, and so forth. In some examples, a user and/or an automatic process may produce and/or maintain no annotation 620, a single annotation 620, multiple annotations 620, and so forth.

In some examples, annotation 620 may comprise auxiliary information related to datasets 610. In some examples, annotation 620 may comprise historic information related to dataset 610. Such historic information may include information related to the source of the dataset and/or of parts of the dataset, historic usages of the dataset and/or of parts of the dataset, and so forth. In some examples, annotation 620 may comprise information about the dataset and/or about items (such as data-points) in the dataset that is not included in the dataset.

In some embodiments, annotation 620 may comprise labels and/or tags corresponding to data-points of dataset 610. In some examples, a label may comprise an assignment of one value from a list of possible values to a data-point. In some examples, a tag may comprise an assignment of any number of values (including zero, one, two, three, etc.) from a list of possible values to a data-point. For example, the list of possible values may contain types (such as mammal, fish, amphibian, reptile and bird), and a label may assign a single type to a data-point (for example, fish label may indicate that the data-point describes an animal that is a fish), while a tag may assign multiple types to a data-point (for example, bird and mammal tags may indicate that the data-point comprise a picture of two animals, one bird and one mammal). In some examples, a label may comprise an assignment of a value from a range of possible values to a data-point. For example, a label with a value of 195.3 may indicate that the data-point describes a subject weighing 195.3 pounds. In some examples, a tag may comprise an assignment of any number of values (including zero, one, two, three, etc.) from a range of possible values to a data-point. For example, tags with values of 74, 73.8 and 74.6 may indicate varying results produced by repeated measurements.

In some embodiments, annotation 620 may comprise desired output corresponding to data-points of dataset 610. In some examples, the desired output may include a picture and/or a video clip. For example, a data-point may include a picture and/or a video clip, and the desired output may include the picture and/or video clip after some processing, such as noise removal, super-resolution, and so forth. In some examples, the desired output may include a mapping. For example, a data-point may include a picture and/or a video clip, and the desired output may include a mapping of pixels and/or regions of the picture and/or video clip to desired segments. In another example, a data-point may include audio data, and the desired output may include a mapping of portions of the audio data to segments. In some examples, the desired output may include audio data. For example, a data-point may include audio data, and the desired output may include the audio data after some processing, such as noise removal, source separation, and so forth. In some examples, the desired output may include processed data. For example, a data-point may include data captured using one or more sensors, and the desired output may include the data after some processing, such as noise removal, convolution, down-sampling, interpolation, and so forth. In some examples, the desired output may include textual information. For example, a data-point may include a picture and/or a video clip, and the desired output may comprise a textual description of the picture and/or video clip. In another example, a data-point may include audio data, and the desired output may comprise a transcription of the audio data. In yet another example, a data-point may include textual information, and the desired output may comprise a synopsis of the textual information.

In some examples, annotation 620 may comprise information arranged in vectors and/or tables. For example, each entry in the vector and/or row in a table and/or column in the table may correspond to a data-point of dataset 610, and the entry may comprise annotation related to that data-point. In some examples, annotation 620 may comprise information arranged in one or more matrixes. For example, each entry in the matrix may correspond to two data-points of dataset 610 according to the row and column of the entry, and the entry may comprise information related to these data-points. In some examples, annotation 620 may comprise information arranged in one or more tensors. For example, each entry in the tensor may correspond to a number of data-points of dataset 610 according to the indices of the entry, and the entry may comprise information related to these data-points. In some examples, annotation 620 may comprise information arranged in one or more graphs and/or one or more hypergraphs. For example, each node in the graph may correspond to a data-point of dataset 610, and an edge of the graph and/or hyperedge of the hypergraph may comprise information related to the data-points connected by the edges and/or hyperedge.

In some embodiments, view 630 may comprise data and information related to datasets 610 and/or annotations 620. In some examples, view 630 may comprise modified versions of one or more datasets of datasets 610 and/or modify versions of one or more annotations of annotations 620. Unless otherwise stated, it is appreciated that any operation discussed with reference to datasets 610 and/or annotations 620, may also be implemented in a similar manner with respect to views 630.

In some examples, view 630 may comprise a unification of one or more datasets of datasets 610. For example, view 630 may comprise a merging rule for merging two or more datasets. In another example, datasets 610 may comprise database tables, and view 630 may comprise SQL expressions for generating a new table out of the original tables and/or generated table. In yet another example, datasets 610 may comprise data-points, and view 630 may comprise a rule for merging data-points, a rule for selecting a subset of the data-points, and so forth.

In some embodiments, view 630 may comprise a unification of one or more annotations of annotations 620. For example, view 630 may comprise a merging rule for merging two or more annotations. In another example, annotations 620 may comprise database tables containing annotation information, and view 630 may comprise SQL expressions for generating a new annotation table out of the original tables and/or generated table. In yet another example, annotations 620 may comprise information corresponding to data-points, and view 630 may comprise a rule for merging the information corresponding to a data-point to obtain new annotation information. Such rule may prioritize information from one annotation source over others, may include a decision mechanism to produce new annotation and/or select an annotation out of the original annotations, and so forth. In another example, annotation 620 may comprise information corresponding to data-points, and view 630 may comprise a rule for selecting information corresponding to a subset of the data-points.

In some embodiments, view 630 may comprise a selection of one or more datasets of datasets 610 and one or more annotations of annotations 620. In some examples, view 630 may comprise a selection of one or more datasets 610 and of a unification of one or more annotations 620, as described above. In some examples, view 630 may comprise a selection of a unification of one or more datasets of datasets 610 (as described above) and of one or more annotations of annotations 620. In some examples, view 630 may comprise a selection of a unification of one or more datasets of datasets 610 and of a unification of one or more annotations of annotations 620. In some examples, view 630 may comprise a selection of one or more other views of views 630.

In some embodiments, algorithms 640 may comprise algorithms for processing information, such as the information contained in datasets 610 and/or annotations 620 and/or views 630 and/or tasks 650 and/or logs 660 and/or policies 670 and/or permissions 680. In some cases, algorithms 640 may further comprise parameters and/or hyper-parameters of the algorithms. For example, algorithms 640 may comprise a plurality of versions of the same core algorithm with different sets of parameters and/or hyper-parameters.

In some embodiments, algorithm 640 may comprise one or more decision rules. For example, a decision rule may compare a computed value to a threshold, and in some cases the threshold may be set based on a parameter and/or a hyper-parameter. In some embodiments, algorithm 640 may be preprogrammed manually. For example, a manually preprogrammed algorithm may implement a heuristic algorithm that has zero or more parameters and/or hyper-parameters. In some embodiments, algorithm 640 may comprise a machine learning algorithm configured to train on training examples, such as training examples included in datasets 610 and/or views 630, to estimate labels and/or tags and/or desired results, such as labels and/or tags and/or desired results included in annotations 620 and/or views 630. For example, algorithm 640 may comprise a kernel based algorithm, such as support vector machine and/or kernel principal component analysis, and the selection of a kernel may be according to a hyper-parameter. For example, algorithm 640 may comprise an artificial neural network, and the structure and/or other characteristics of the artificial neural network may be selected according to hyper-parameters. For example, algorithm 640 may comprise a clustering and/or a segmentation algorithm, and the number of desired clusters and/or segments may be selected according to a hyper-parameter. For example, algorithm 640 may comprise a factorization algorithm, and the number of desired factors may be determined according to a hyper-parameter. For example, a stopping condition of algorithm 640 may be based on hyper-parameters. In some examples, algorithm 640 may comprise a regression algorithm, a classification algorithm, a clustering algorithm, a segmentation algorithm, a factorization algorithm, a source separation algorithm, a dimensional reduction algorithm, a feature selection algorithm, and so forth. In some examples, algorithms 640 may comprise an algorithm that combines two or more other algorithms into a single algorithm.

In some embodiments, algorithms 640 may comprise algorithms for processing information and data from an external source. In some examples, the external data source may include a sensor (such as audio sensor, image sensor, motion sensor, positioning sensor, etc.), a user, an external device, an automatic process, external data repository, and so forth. Some examples of external data repositories may include a public database, a blockchain, a web crawler, and so forth.

In some embodiments, algorithms 640 may process information and data from an external source to update datasets 610 and/or annotations 620 and/or views 630 and/or algorithms 640 and/or tasks 650 and/or logs 660 and/or policies 670 and/or permissions 680. In some examples, based on the data from the external source, the algorithm may add information to one or more datasets, remove information from one or more datasets, modify information of one or more datasets, and so forth. For example, the algorithm may add new data-points containing the data from the external source to a dataset, update existing data-points according to the data from the external source, remove data-points that were made obsolete according to data from the external source, and so forth. In some examples, based on the data from the external source, the algorithm may add information to one or more annotations, remove information from one or more annotations, modify information of one or more annotations, and so forth. For example, the algorithm may add new labels and/or tags and/or desired results containing data from the external source to an annotation, update existing labels and/or tags and/or desired results according to the data from the external source, remove labels and/or tags and/or desired results that were made obsolete according to data from the external source, and so forth. In some examples, algorithms 640 may process information and data from an external source to update one or more data-points of datasets 610 and one or more corresponding labels and/or tags and/or desired results of annotations 620. In some examples, based on the data from the external source, the algorithm may create a new view, delete a view, modify a view, and so forth. In some examples, the algorithm may create a new view to match an observed phenomenon and/or environment. In some examples, the algorithm may maintain views of items relevant to an environment, device, user, problem, and so forth. Some examples of such items may include objects, people, faces, gestures, voices, sounds, and so forth. For example, observing an environment with some types of objects may cause the algorithm to create a view containing examples of the observed types, which may later be used to train an object detector. Furthermore, detecting a change in said environment, such as an introduction of a new type of objects to the environment or removal of a certain type of objects from the environment, may cause the algorithm to modify the view to match the change. Furthermore, when a situation change in a way that makes the environment expendable, the algorithm may delete the corresponding view. For example, observing a conversation of two speakers may cause the algorithm to create a view containing voice samples of the two speakers. Furthermore, detecting a change in the conversation, for example an introduction of a new speaker to the conversation, may cause the algorithm to add voice samples of the new speaker to the view. Furthermore, end of the conversation may cause the algorithm to delete the corresponding view. In another example, when the data from the external source describes a household containing a child and a dog, the algorithm may create a view containing image examples of children and of dogs by merging datasets and/or annotations of image examples of children with datasets and/or annotations of image examples of dogs. When the data from the external source indicates an addition of a cat to the household, image examples of cats may be added to the view by merging additional datasets and/or annotations of image examples of cats into the view. Furthermore, when the data from the external source indicates that the dog left the household, information related to the image examples of dogs may be removed from the view.

In some embodiments, algorithms 640 may process information and data from datasets 610 and/or annotations 620 and/or views 630 and/or algorithms 640 and/or tasks 650 and/or logs 660 and/or policies 670 and/or permissions 680 to update datasets 610 and/or annotations 620 and/or views 630 and/or algorithms 640 and/or tasks 650 and/or logs 660 and/or policies 670 and/or permissions 680. For example, based on data from some source datasets of datasets 610, the algorithm may update the source datasets, update other datasets, update annotations associated with the source datasets, update other annotations, update views based on the source datasets, update other views, and so forth. Similarly, based on data from some source annotations of annotations 620, the algorithm may update the source annotations, update other annotations, update datasets associated with the source annotations, update other datasets, update views based on the source annotations, update other views, and so forth. Furthermore, based on data from some source views of views 630, the algorithm may update the source views, update other views, update datasets and/or annotations that the source views are based on, update other datasets and/or annotations, and so forth.

In some examples, updating datasets 610, for example by an algorithm processing data from datasets 610 and/or annotations 620 and/or views 630 as described above, may comprise adding new datasets to datasets 610 (for example where a new dataset may comprise data-points containing results of calculations based on the processed information, data-points selected from other datasets based on the results of the calculations, etc.), removing datasets from datasets 610 (for example removing datasets that were made obsolete according to a calculation based on the processed information), modifying some of the datasets of datasets 610, and so forth. In some examples, modifying a dataset, for example by an algorithm processing data from datasets 610 and/or annotations 620 and/or views 630 as described above, may comprise adding new data-points to the dataset (for example where a new data-point contains a result of a calculation based on the processed information), modifying data-points of the dataset (for example changing a value of a data-point according to a calculation based on the processed information), removing data-points from the dataset (for example removing data-points that were made obsolete according to a calculation based on the processed information), and so forth.

In some examples, updating an annotation, for example by an algorithm processing data from datasets 610 and/or annotations 620 and/or views 630 as described above, may comprise adding new annotations to annotations 620 (for example where a new annotation may comprise tags and/or labels and/or desired results containing results of calculations based on the processed information, tags and/or labels and/or desired results selected from other annotations based on the results of the calculations, etc.), removing annotations from annotations 620 (for example removing annotations that were made obsolete according to a calculation based on the processed information), modifying some of the annotations of annotations 620, and so forth. In some examples, modifying an annotation may comprise adding tags and/or labels and/or desired results to the annotation (for example where the value of the label and/or tag and/or desired result is according to a result of a calculation based on the processed information), removing tags and/or labels and/or desired results from the annotation (for example removing labels and/or tags and/or desired results that were made obsolete according to the calculation's result), modifying tags and/or labels and/or desired results in the annotation (for example according to the calculation's result), and so forth. For example, the algorithm may add and/or modify and/or remove labels and/or tags and/or desired results of the annotation that corresponds to data-points of datasets 610 based on a result of a calculation that is based on values of said data-points. In another example, the algorithm may produce a new annotation based on several other source annotations that deal with the same dataset, for example using a voting mechanism. In some examples, the algorithm may update the produced annotation in response to a change in the source annotations, may delete the produced annotation in response a deletion of one of the source annotations, and so forth.

In some examples, updating a view, for example by an algorithm processing data from datasets 610 and/or annotations 620 and/or views 630 as described above, may comprise adding new views to views 630, removing views from views 630, modifying some of the views of views 630, and so forth. For example, observing a dataset and/or an annotation with some distribution of elements may cause the algorithm to create a view containing a sample of the elements with a different distribution. Furthermore, detecting a change of the dataset and/or annotation that caused a change of said distribution may lead the algorithm to modify the view to match the change. Furthermore, when changes to the dataset and/or the annotation cause the said distribution to reach a certain desired property, the algorithm may remove the view.

In some embodiments, algorithms 640 may process information and data from datasets 610 and/or one or more annotations 620 and/or one or more views 630 and/or algorithms 640 and/or tasks 650 and/or logs 660 and/or policies 670 and/or permissions 680 to update one or more algorithms 640. In some examples, based on the processed information, the algorithm may create a new algorithm, delete an algorithm, modify an algorithm, and so forth. For example, observing a dataset and/or an annotation and/or a view with some distribution of elements may cause the algorithm to create a new algorithm with a set of hyper-parameters matching the distribution. Furthermore, detecting a change to the dataset and/or annotation and/or view that caused a change in said distribution may cause the algorithm to modify the set of hyper-parameters to match the changed distribution. Furthermore, when changes to the dataset and/or the annotation and/or the view cause the said distribution to reach a certain desired property, the algorithm may delete the created algorithm.

In some embodiments, tasks 650 may comprise one or more tasks waiting for execution. In some examples, a task may comprise a selection of one or more datasets of datasets 610, of one or more annotations of annotations 620, of one or more views of views 630, of one or more algorithms of algorithms 640, and so forth. For example, a task may comprise a selection of a dataset and an algorithm, and the execution of the task may comprise applying the selected algorithm to the data of the selected dataset. In another example, a task may comprise a selection of a dataset, an annotation and an algorithm, and the execution of the task may comprise applying the selected algorithm to the data of the selected dataset and the selected annotation. In yet another example, a task may comprise a selection of an annotation and an algorithm, and the execution of the task may comprise applying the selected algorithm to information included in the selected annotation. In another example, a task may comprise a selection of a view and an algorithm, and execution of the task may comprise applying the selected algorithm to the selected view.

In some embodiments, tasks 650 may comprise scheduling information. For example, the scheduling information may specify priorities assigned to the tasks, in the form of a priority values assigned to the tasks (such as high, medium, low, numerical priority values, etc.), in the form of an ordering of the tasks according to ascending or descending priority, and so forth. In some examples, the scheduling information may specify preferred execution times, constraints on execution times, preferred execution frequencies, constraints on execution frequencies, and so forth.

In some embodiments, tasks 650 may comprise execution requirements. In some examples, the execution requirements may comprise details about preferred execution conditions and/or settings of the tasks. For example, execution requirements may comprise a specification of hardware requirements (such as memory size, processing power, etc.) of a task. In another example, execution requirements may comprise an indication of specific devices and/or specific device types required to execute the task (such as apparatus 200, server 300, cloud platform 400, computational node 500, and so forth). In yet another example, execution requirements may comprise a specification of software requirements of a task (such as operation system, software libraries, software modules, and so forth).

In some embodiments, tasks 650 may comprise tasks for manual execution. In some examples, tasks for manual execution may include indications of specific persons required to execute the task, of types of persons required to execute the task, of skills required to execute the task, and so forth.

In some embodiments, algorithms 640 may process information and data from an external source to update one or more tasks of tasks 650. In some examples, based on the data from the external source, the algorithm may create a new task, delete a task, modify a task, and so forth. For example, in response to an observed change in an environment, the algorithm may create a new task dealing with datasets and/or annotations and/or views related to the environment and/or the observed change, may update a task related to the environment and/or the observed change, may delete a task that became obsolete by the observed change, and so forth.

In some embodiments, algorithms 640 may process information and data from datasets 610 and/or annotations 620 and/or views 630 and/or algorithms 640 and/or tasks 650 and/or logs 660 and/or policies 670 and/or permissions 680 to update tasks 650. In some examples, based on the data from datasets 610 and/or annotations 620 and/or views 630 and/or algorithms 640 and/or tasks 650 and/or logs 660 and/or policies 670 and/or permissions 680, the algorithm may create a new task, delete a task, modify a task, and so forth. For example, observing an update to a dataset and/or to an annotation and/or to a view and/or to an algorithm may cause the algorithm to create a new task dealing with the updated items, may cause the algorithm to modify a task dealing with the updated items, may cause the algorithm to remove a task that was made obsolete by the update, and so forth.

In some embodiments, logs 660 may comprise historic information related to datasets 610, annotations 620, views 630, algorithms 640, tasks 650, logs 660, policies 670, permissions 680, and so forth. In some examples, a log may comprise historic information about creations and/or deletions and/or modifications of datasets 610, elements of a dataset, annotations 620, elements of an annotation, views 630, elements of a view, algorithms 640, core algorithms of an algorithm, parameters and/or hyper-parameters of an algorithm, tasks 650, details of a task, logs 660, a log, entries of a log, policies 670, a policy, an element of a policy, permissions 680, a permission record, and so forth.

In some examples, a log may comprise historic information about past execution details of algorithms 640 and/or tasks 650. For example, such execution details may include the execution time, the execution duration, the executing device, the executing person, the actual resource requirement, software versions of software used in the execution, and so forth. For example, such execution details may comprise errors and/or results of the execution and/or statistics based on the results of the execution. Furthermore, such execution details may comprise versions of datasets 610, annotations 620, views 630, algorithms 640, tasks 650, logs 660, policies 670, permissions 680, etc., used in the execution.

In some embodiments, policies 670 may comprise a specification of what actions need to be taken, for example periodically and/or in response to a change. In some examples, execution manager module 690 may act according to policies 670. In some examples, based on policies 670, execution manager module 690 may create and/or delete and/or modify datasets 610, a dataset, elements of a dataset, annotations 620, an annotation, elements of an annotation, views 630, a view, elements of a view, algorithms 640, an algorithm, core algorithms of an algorithm, parameters and/or hyper-parameters of an algorithm, tasks 650, a task, details of a task, logs 660, elements of a log, policies 670, a policy, a detail of a policy, permissions 680, a permission record, and so forth.

In some embodiments, permissions 680 may specify which user and/or automatic process and/or algorithm (such as an algorithm of algorithms 640) and/or task (such as a task of tasks 650) may access and/or create and/or modify and/or delete which item (such as datasets 610, a dataset, elements of a dataset, annotations 620, an annotation, elements of an annotation, views 630, a view, elements of a view, algorithms 640, an algorithm, core algorithms of an algorithm, parameters and/or hyper-parameters of an algorithm, tasks 650, a task, details of a task, logs 660, a log, elements of a log, policies 670, a policy, a detail of a policy, permissions 680, a permission record, details of a permission record, and so forth).

In some embodiments, datasets 610 and/or annotations 620 and/or views 630 and/or algorithms 640 and/or tasks 650 and/or logs 660 and/or policies 670 and/or permissions 680 may be created and/or deleted and/or modified manually and/or automatically.

In some embodiments, a method, such as methods 700 and 800, may comprise of one or more steps. In some examples, a method, as well as all individual steps therein, may be performed by various aspects of apparatus 200, server 300, cloud platform 400, computational node 500, and so forth. For example, the method may be performed by processing units 220 executing software instructions stored within memory units 210 and/or within shared memory modules 410. In some examples, a method, as well as all individual steps therein, may be performed by a dedicated hardware. In some examples, computer readable medium (such as a non-transitory computer readable medium) may store data and/or computer implementable instructions for carrying out a method. Some examples of possible execution manners of a method may include continuous execution (for example, returning to the beginning of the method once the method normal execution ends), periodically execution, executing the method at selected times, execution upon the detection of a trigger (some examples of such trigger may include a trigger from a user, a trigger from another method, a trigger from an external device, etc.), and so forth.

In some embodiments, machine learning algorithms (also referred to as machine learning models in the present disclosure) may be trained using training examples, for example in the cases described below. Some examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear algorithms, non-linear algorithms, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by an process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

In some embodiments, trained machine learning algorithms (also referred to as trained machine learning models in the present disclosure) may be used to analyze inputs and generates outputs, for example in the cases described below. In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value for an item depicted in the image (such as an estimated property of the item, such as size, volume, age of a person depicted in the image, cost of a product depicted in the image, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs. Some examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the an artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network, for example as described below in relation to FIGS. 10C, 10D, 10E, 10F. and 10G.

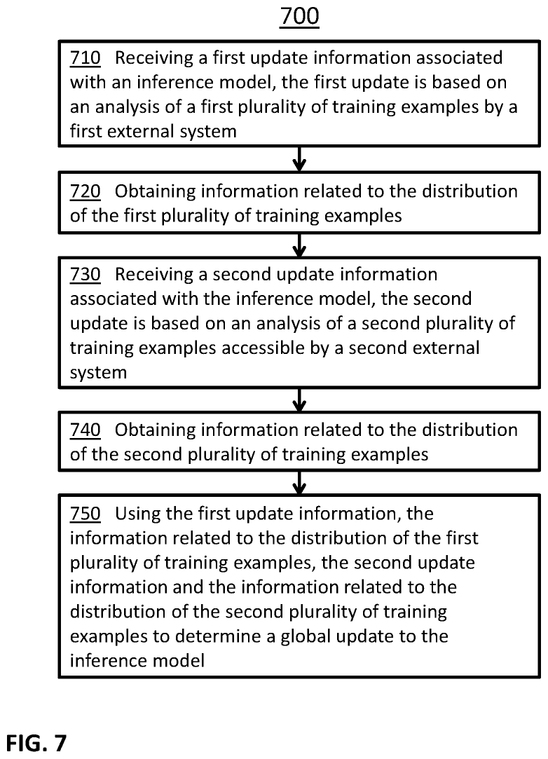

FIG. 7 illustrates an example of a method 700 for determining a global update to inference models using update information from a plurality of external systems. In this example, method 700 may comprise: receiving a first update information associated with an inference model, the first update is based on an analysis of a first plurality of training examples by a first external system (Step 710); obtaining information related to the distribution of the first plurality of training examples (Step 720); receiving a second update information associated with the inference model, the second update is based on an analysis of a second plurality of training examples accessible by a second external system (Step 730); obtaining information related to the distribution of the second plurality of training examples (Step 740); and using the first update information, the information related to the distribution of the first plurality of training examples, the second update information and the information related to the distribution of the second plurality of training examples to determine a global update to the inference model (Step 750). In some implementations, method 700 may comprise one or more additional steps, while some of the steps listed above may be modified or excluded. In some implementations, one or more steps illustrated in FIG. 7 may be executed in a different order and/or one or more groups of steps may be executed simultaneously and/or a plurality of steps may be combined into single step and/or a single step may be broken down to a plurality of steps.

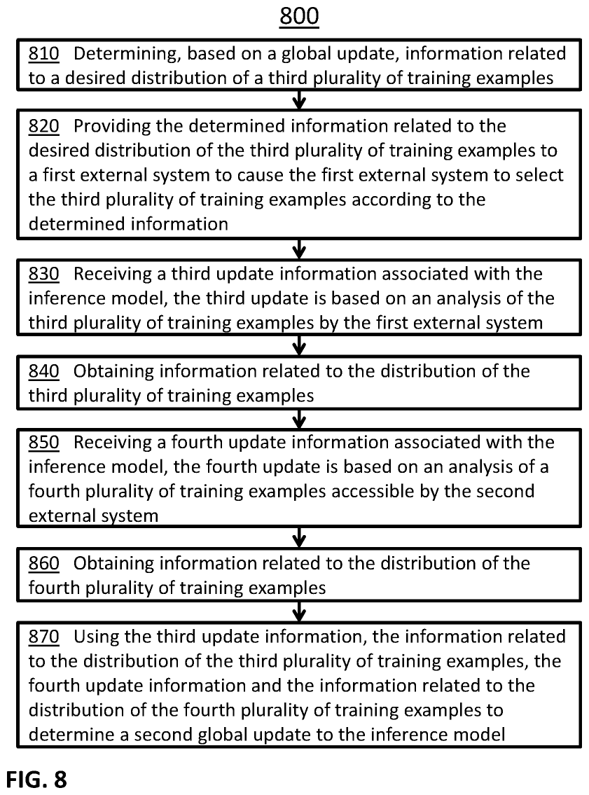

FIG. 8 illustrates an example of a method 800 for determining a global update to inference models using update information from a plurality of external systems. In this example, method 800 may comprise: determining, based on a global update, information related to a desired distribution of a third plurality of training examples (Step 810); providing the determined information related to the desired distribution of the third plurality of training examples to a first external system to cause the first external system to select the third plurality of training examples according to the determined information (Step 820); receiving a third update information associated with the inference model, the third update is based on an analysis of the third plurality of training examples by the first external system (Step 830); obtaining information related to the distribution of the third plurality of training examples (Step 840); receiving a fourth update information associated with the inference model, the fourth update is based on an analysis of a fourth plurality of training examples accessible by the second external system (Step 850); obtaining information related to the distribution of the fourth plurality of training examples (Step 860); and using the third update information, the information related to the distribution of the third plurality of training examples, the fourth update information and the information related to the distribution of the fourth plurality of training examples to determine a second global update to the inference model (Step 870). In some implementations, method 800 may comprise one or more additional steps, while some of the steps listed above may be modified or excluded. In some implementations, one or more steps illustrated in FIG. 8 may be executed in a different order and/or one or more groups of steps may be executed simultaneously and/or a plurality of steps may be combined into single step and/or a single step may be broken down to a plurality of steps. In one example, method 800 may be executed after method 700, for example based on the global update to the inference model determined by method 700. For example, in response to a first global update to the inference model determined by method 700, method 800 may be executed, and in response to a second global update to the inference model determined by method 700, executing method 800 may be withheld.

One possible implementation of the first external system of method 700 and/or of method 800 may include external system 160a, and the second external system of method 700 and/or of method 800 may include external system 160b. In one example, the first plurality of training examples of method 700 and/or the third plurality of training examples of method 800 may be included in dataset 170a. In one example, the second plurality of training examples of method 700 and/or the fourth plurality of training examples of method 800 may be included in dataset 170b.

In some examples, the inference model of method 700 and/or of method 800 may comprise at least one of an artificial neural network, a classifier and a regression model. Some other non-limiting examples of such inference model may include an image analysis model, an image segmentation model, an object detection model, an object recognition model, an audio analysis model, a speech recognition model, and so forth.

In some examples, the first plurality of training examples of method 700 may be accessible by the first external system and not accessible by the second external system. In some examples, the second plurality of training examples of method 700 may be accessible by the second external system and not accessible by the first external system. In some examples, the third plurality of training examples of method 800 may be accessible by the first external system and not accessible by the second external system. In some examples, the fourth plurality of training examples of method 800 may be accessible by the second external system and not accessible by the first external system.

In some embodiments, update information associated with an inference model may be received, the update may be based on an analysis of a plurality of training examples by an external system. For example, Step 710 may comprise receiving a first update information associated with an inference model, the first update information may be based on an analysis of a first plurality of training examples by a first external system. In another example, Step 730 may comprise receiving a second update information associated with the inference model, the second update information may be based on an analysis of a second plurality of training examples accessible by a second external system. In yet another example, Step 830 may comprise receiving a third update information associated with the inference model, the third update information may be based on an analysis of the third plurality of training examples by the first external system. In an additional example, Step 850 may comprise receiving a fourth update information associated with the inference model, the fourth update information may be based on an analysis of a fourth plurality of training examples accessible by the second external system.

In some examples, the received update information associated with an inference model (for example by Step 710 and/or Step 730 and/or Step 830 and/or Step 850) may be based on an analysis of a plurality of training examples (for example by an external device). For example, the received update information associated with an inference model may be based on a function of the plurality of training examples, on results of applying the plurality of training examples to the inference model, on a function of the results of applying the plurality of training examples to the inference model, on results of intermediate calculations performed by the inference model when applying the plurality of training examples to the inference model, on a function of the results of intermediate calculations performed by the inference model when applying the plurality of training examples to the inference model, and so forth. Some non-limiting examples of such function may include a linear function, a non-linear function, a polynomial function, an exponential function, and so forth. In one example, the inference model may comprise an artificial neural network, and the received update information associated with an inference model may be calculated using backpropagation corresponding to the plurality of training examples and the artificial neural network. In another example, the inference model may comprise a function, and the received update information may be based on a gradient and/or a Hessian corresponding to the plurality of training examples and the function. In yet another example, the inference model may comprise a parametric function, an algorithm for selecting parameters of the parametric function may include usage of iterative update steps, and the received update information may include information for an update step corresponding to the plurality of training examples and the function.

In some examples, the update information associated with an inference model may be read from a memory unit (such as memory units 210, shared memory modules 410, and so forth), for example by Step 710 and/or by Step 730 and/or by Step 830 and/or by Step 850. In some examples, the update information associated with an inference model may be received from an external system. For example, Step 710 may comprise receiving the first update information associated with an inference model from the first external system. In another example, Step 730 may comprise receiving the second update information associated with an inference model from the second external system. In yet another example, Step 830 may comprise receiving the third update information associated with the inference model from the first external system. In an additional example, Step 850 may comprise receiving the fourth update information associated with the inference model from the second external system. In one example, the update information associated with an inference model may be received from the external system using a communication device, for example using communication modules 230. In one example, the update information associated with an inference model may be received from the external system through a communication network, such as communication network 130. In one example, the update information associated with an inference model may be received from the external system through an intermediate device, such as an intermediate processing device, a shared memory device, and so forth.

In some examples, received update information based on an analysis of a plurality of training examples (for example by an external system) may be insufficient to reconstruct any training example of the plurality of training examples. For example, the first update information received by Step 710 may be insufficient to reconstruct any training example of the first plurality of training examples. In another example, the second update information received by Step 730 may be insufficient to reconstruct any training example of the second plurality of training examples. In yet another example, the third update information received by Step 830 may be insufficient to reconstruct any training example of the third plurality of training examples. In an additional example, the fourth update information received by Step 850 may be insufficient to reconstruct any training example of the fourth plurality of training examples.

In some examples, received update information based on an analysis of a plurality of training examples (for example by an external system) may be insufficient to reconstruct at least one training example of the plurality of training examples. For example, the first update information received by Step 710 may be insufficient to reconstruct at least one training example of the first plurality of training examples. In another example, the second update information received by Step 730 may be insufficient to reconstruct at least one training example of the second plurality of training examples. In yet another example, the third update information received by Step 830 may be insufficient to reconstruct at least one training example of the third plurality of training examples. In an additional example, the fourth update information received by Step 850 may be insufficient to reconstruct at least one training example of the fourth plurality of training examples.

In some embodiments, information related to a distribution of a plurality of training examples may be obtained. For example, Step 720 may comprise obtaining information related to the distribution of the first plurality of training examples of Step 710. In another example, Step 740 may comprise obtaining information related to the distribution of the second plurality of training examples of Step 730. In yet another example, Step 840 may comprise obtaining information related to the distribution of the third plurality of training examples of Step 830. In an additional example, Step 860 may comprise obtaining information related to the distribution of the fourth plurality of training examples of Step 850.

In some examples, the obtained (for example by Step 720 and/or Step 740 and/or Step 840 and/or Step 860) information related to a distribution of a plurality of training examples (for example, the first plurality of training examples of method 700, the second plurality of training examples of method 700, the third plurality of training examples of method 800, the fourth plurality of training examples of method 800, etc.) may be based on an analysis of a plurality of training examples (for example by an external device). In some examples, the received information related to the distribution of the plurality of training examples (for example by Step 720 and/or Step 740 and/or Step 840 and/or Step 860) may include the distribution of the plurality of training examples, the distribution of labels corresponding to the plurality of training examples, the distribution of the results of applying the plurality of training examples to the inference model, the distribution of results of intermediate calculations performed by the inference model when applying the plurality of training examples to the inference model, a function of the distribution of the plurality of training examples, a function of the distribution of labels corresponding to the plurality of training examples, a function of the distribution of the results of applying the plurality of training examples to the inference model, a function of the distribution of results of intermediate calculations performed by the inference model when applying the plurality of training examples to the inference model, an approximation of the distribution of the plurality of training examples, an approximation of the distribution of labels corresponding to the plurality of training examples, an approximation of the distribution of the results of applying the plurality of training examples to the inference model, an approximation of the distribution of results of intermediate calculations performed by the inference model when applying the plurality of training examples to the inference model, a parameter of such distribution, a parameter of such approximation, and so forth. Some non-limiting examples of such function may include a linear function, a non-linear function, a polynomial function, an exponential function, and so forth. In some examples, the plurality of training examples may be segmented into a plurality of categories, for example where each training example corresponds to one of the plurality of categories, and the received information related to the distribution of the plurality of training examples (for example by Step 720 and/or Step 740 and/or Step 840 and/or Step 860) may be based on the number of training examples of the plurality of training examples corresponding to one or more of the plurality of categories (for example, the number of training examples corresponding to a single category, the number of training examples corresponding to each one of plurality of categories, and so forth).

In some examples, information related to a distribution of a plurality of training examples may be read from a memory unit (such as memory units 210, shared memory modules 410, and so forth), for example by Step 720 and/or by Step 740 and/or by Step 840 and/or by Step 860. In some examples, information related to a distribution of a plurality of training examples may be received from an external system. For example, Step 720 may comprise receiving the information related to the distribution of the first plurality of training examples of Step 710 from the first external system. In another example, Step 740 may comprise receiving the information related to the distribution of the second plurality of training examples of Step 730 from the second external system. In yet another example, Step 840 may comprise receiving the information related to the distribution of the third plurality of training examples of Step 830 from the first external system. In an additional example, Step 860 may comprise receiving the information related to the distribution of the fourth plurality of training examples of Step 850 from the second external system. In one example, the information related to the distribution of a plurality of training examples may be received from the external system using a communication device, for example using communication modules 230. In one example, the information related to the distribution of a plurality of training examples may be received from the external system through a communication network, such as communication network 130. In one example, the information related to the distribution of a plurality of training examples may be received from the external system through an intermediate device, such as an intermediate processing device, a shared memory device, and so forth.

In some examples, the information related to the distribution of the first plurality of training examples received by Step 720 may differ from the information related to the distribution of the second plurality of training examples received by Step 740. For example, the distribution of the first plurality of training examples may differ from the distribution of the second plurality of training examples, and the difference between the information received by Step 720 and the information received by Step 740 may reflect this difference between the distributions. In some examples, the information related to the distribution of the third plurality of training examples received by Step 840 may differ from the information related to the distribution of the fourth plurality of training examples received by Step 860. For example, the distribution of the third plurality of training examples may differ from the distribution of the fourth plurality of training examples, and the difference between the information received by Step 840 and the information received by Step 860 may reflect this difference between the distributions.

In some embodiments, a global update to the inference model may be determined based on a plurality of update information instances, each instance of update information may be based on an analysis of a different plurality of training examples, and on information related to the different distributions of the different pluralities of training examples. For example, Step 750 may comprise using the first update information received by Step 710, the information related to the distribution of the first plurality of training examples obtained by Step 710, the second update information received by Step 730, and the information related to the distribution of the second plurality of training examples obtained by Step 750, to determine a global update to the inference model. In another example, Step 870 may comprise using the third update information received by Step 830, the information related to the distribution of the third plurality of training examples obtained by Step 840, the fourth update information received by Step 850, and the information related to the distribution of the fourth plurality of training examples obtained by Step 860, to determine a second global update to the inference model.

In some examples, information related to a distribution of a plurality of training examples may be used to determine a weight for the corresponding update information. For example, Step 750 may use the information related to the distribution of the first plurality of training examples to determine a weight for the first update information. In another example, Step 750 may use the information related to the distribution of the second plurality of training examples to determine a weight for the second update information. In yet another example, Step 870 may use the information related to the distribution of the third plurality of training examples to determine a weight for the third update information. In an additional example, Step 870 may use the information related to the distribution of the fourth plurality of training examples to determine a weight for the fourth update information. In one example, the determined weight for the update information may be a function of any data included in the corresponding information related to the distribution of the plurality of training examples, such as a function of the corresponding distribution of the plurality of training examples, a function of the corresponding distribution of labels corresponding to the plurality of training examples, a function of the corresponding distribution of the results of applying the plurality of training examples to the inference model, a function of the corresponding distribution of results of intermediate calculations performed by the inference model when applying the plurality of training examples to the inference model, a function of a parameter of such distribution, a function of an approximation of the corresponding distribution of the plurality of training examples, a function of an approximation of the corresponding distribution of labels corresponding to the plurality of training examples, a function of an approximation of the corresponding distribution of the results of applying the plurality of training examples to the inference model, a function of an approximation of the corresponding distribution of results of intermediate calculations performed by the inference model when applying the plurality of training examples to the inference model, a function of a parameter of such approximated distribution, and so forth. In some examples, in response to first information related to a distribution of a plurality of training examples, a first weight may be determined for the corresponding update information, and in response to second information related to a distribution of a plurality of training examples, a second weight may be determined for the corresponding update information, the second weight may differ from the first weight. For example, in response to first information related to the distribution of the first plurality of training examples, Step 750 may determine a first weight for the first update information, and in response to second information related to the distribution of the first plurality of training examples, Step 750 may determine a second weight for the first update information, the second weight may differ from the first weight. In another example, in response to first information related to the distribution of the second plurality of training examples, Step 750 may determine a first weight for the second update information, and in response to second information related to the distribution of the second plurality of training examples, Step 750 may determine a second weight for the second update information, the second weight may differ from the first weight.

In some examples, a weight for update information may be determined based on corresponding information related to the distribution of the plurality of training examples corresponding to the update information, and based on information related to the distribution of other pluralities of training examples. For example, Step 750 may use the information related to the distribution of the first plurality of training examples and the information related to the distribution of the second plurality of training examples to determine a weight for the first update information. In another example, Step 750 may use the information related to the distribution of the first plurality of training examples and the information related to the distribution of the second plurality of training examples to determine a weight for the second update information. In yet another example, Step 870 may use the information related to the distribution of the third plurality of training examples and the information related to the distribution of the fourth plurality of training examples to determine a weight for the third update information. In an additional example, Step 870 may use the information related to the distribution of the third plurality of training examples and the information related to the distribution of the fourth plurality of training examples to determine a weight for the fourth update information. In one example, the determined weight for the update information may be a function of any data included in the corresponding information related to the distribution of the plurality of training examples and/or any data included in the information related to the distributions of the other pluralities of training examples. In one example, data included in the corresponding information related to the distribution of the plurality of training examples may be compared with data included in the information related to the distribution of another plurality of training examples, and the determined weight for the update information may be based on a result of the comparison. For example, Step 750 may compare the information related to the distribution of the first plurality of training examples with the information related to the distribution of the second plurality of training examples, in response to a first result of the comparison, Step 750 may determine a first weight for the first update information, and in response to second result of the comparison, Step 750 may determine a second weight for the first update information, the second weight may differ from the first weight. In another example, Step 750 may compare the information related to the distribution of the first plurality of training examples with the information related to the distribution of the second plurality of training examples, in response to a first result of the comparison, Step 750 may determine a first weight for the second update information, and in response to second result of the comparison, Step 750 may determine a second weight for the second update information, the second weight may differ from the first weight. In yet another example, Step 870 may compare the information related to the distribution of the third plurality of training examples with the information related to the distribution of the fourth plurality of training examples, in response to a first result of the comparison, Step 870 may determine a first weight for the third update information, and in response to second result of the comparison, Step 870 may determine a second weight for the third update information, the second weight may differ from the first weight. In an additional example, Step 870 may compare the information related to the distribution of the third plurality of training examples with the information related to the distribution of the fourth plurality of training examples, in response to a first result of the comparison, Step 870 may determine a first weight for the fourth update information, and in response to second result of the comparison, Step 870 may determine a second weight for the fourth update information, the second weight may differ from the first weight. In yet another example, Step 870 may compare the information related to the distribution of the third plurality of training examples with the information related to the distribution of the first plurality of training examples, in response to a first result of the comparison, Step 870 may determine a first weight for the third update information, and in response to second result of the comparison, Step 870 may determine a second weight for the third update information, the second weight may differ from the first weight. In an additional example, Step 870 may compare the information related to the distribution of the fourth plurality of training examples with the information related to the distribution of the second plurality of training examples, in response to a first result of the comparison, Step 870 may determine a first weight for the fourth update information, and in response to second result of the comparison, Step 870 may determine a second weight for the fourth update information, the second weight may differ from the first weight.

In some examples, Step 750 may use the one or more weights determined for update information to determine the global update to the inference model, and Step 870 may use the one or more weights determined for update information to determine the second global update to the inference model. For example, Step 750 may use the first update information, the weight for the first update information, the second update information and the weight for the second update information to determine the global update to the inference model. In another example, Step 870 may use the third update information, the weight for the third update information, the fourth update information and the weight for the fourth update information to determine the global update to the inference model. In some examples, a function of the one or more determined weights and the corresponding update information instances may be used to determine the global update to the inference model or the second global update to the inference model. For example, denoting the determined weights be w1 and w2, and denoting the corresponding update information instances be u1 and u2, the global update to the inference model (or the second global update to the inference model) may be f(w1, f1(u1), w2, f(u2)), where f1(u1) is a function of update information u1, f2(u2) is a function of update information u2, and f(w1, f1(u1), w2, f(u2)) is a function of w1, f1(u1), w2 and f(u2). Some non-limiting examples of such functions f1(u1), f2(u2) and f(w1, f1(u1), w2, f(u2)) may include a linear function, a non-linear function, a polynomial function, an exponential function, and so forth.

In some examples, Step 750 may determine the global update to the inference model based on a gradient descent update of the inference model. For example, Step 750 may comprise using the first update information received by Step 710, the information related to the distribution of the first plurality of training examples obtained by Step 710, the second update information received by Step 730, and the information related to the distribution of the second plurality of training examples obtained by Step 750, to determine a gradient (or a direction of a gradient) of a function, and Step 750 may use the determined gradient (or the determined direction of the gradient) to determine the global update to the inference model.

In some examples, Step 870 may determine the second global update to the inference model based on a gradient descent update of the inference model. For example, Step 870 may comprise using the third update information received by Step 830, the information related to the distribution of the third plurality of training examples obtained by Step 840, the fourth update information received by Step 850, and the information related to the distribution of the fourth plurality of training examples obtained by Step 860, to determine a gradient (or a direction of a gradient) of a function, and Step 870 may use the determined gradient (or the determined direction of the gradient) to determine the second global update to the inference model.

In one example, the first update information received by Step 710 may comprise at least a direction of at least a portion of a first gradient determined using the first plurality of training examples, for example by the first external system. In one example, the second update information received by Step 730 may comprise at least a direction of at least a portion of a second gradient determined using the second plurality of training examples, for example by the second external system. In one example, the third update information received by Step 830 may comprise at least a direction of at least a portion of a third gradient determined using the third plurality of training examples, for example by the first external system. In one example, the second update information received by Step 850 may comprise at least a direction of at least a portion of a fourth gradient determined using the fourth plurality of training examples, for example by the second external system. In some examples, Step 750 may comprise using the information related to the distribution of the first plurality of training examples and the information related to the distribution of the second plurality of training examples to calculate an aggregate of the direction of the at least a portion of the first gradient determined using the first plurality of training examples and the direction of at least a portion of a second gradient determined using the second plurality of training examples. For example, Step 750 may calculate the aggregate of the direction of the at least a portion of the first gradient and the direction of at least a portion of a second gradient using a function of the information related to the distribution of the first plurality of training examples, the information related to the distribution of the second plurality of training examples, the direction of the at least a portion of the first gradient, and the direction of at least a portion of a second gradient. In another example, Step 750 may calculate the aggregate of the direction of the at least a portion of the first gradient and the direction of at least a portion of a second gradient using a function of the weight for the first update information (determined as described above), the weight for the second update information (determined as described above), the direction of the at least a portion of the first gradient, and the direction of at least a portion of a second gradient. In some examples, Step 870 may comprise using the information related to the distribution of the third plurality of training examples and the information related to the distribution of the fourth plurality of training examples to calculate an aggregate of the direction of the at least a portion of the third gradient determined using the third plurality of training examples and the direction of at least a portion of a fourth gradient determined using the fourth plurality of training examples. For example, Step 870 may calculate the aggregate of the direction of the at least a portion of the third gradient and the direction of at least a portion of a fourth gradient using a function of the information related to the distribution of the third plurality of training examples, the information related to the distribution of the fourth plurality of training examples, the direction of the at least a portion of the third gradient, and the direction of at least a portion of a fourth gradient. In another example, Step 870 may calculate the aggregate of the direction of the at least a portion of the third gradient and the direction of at least a portion of a fourth gradient using a function of the weight for the third update information (determined as described above), the weight for the fourth update information (determined as described above), the direction of the at least a portion of the third gradient, and the direction of at least a portion of a fourth gradient. In one example, Step 750 may use the calculated aggregate of the direction of the at least a portion of the first gradient and the direction of at least a portion of a second gradient to determine the global update to the inference model. In one example, Step 870 may use the calculated aggregate of the direction of the at least a portion of the third gradient and the direction of at least a portion of a fourth gradient to determine the second global update to the inference model. For example, the global update to the inference model (or a second global update to the inference model) may comprise a step in the direction of the calculated aggregate (or in the opposite direction of the calculated aggregate).

In one example, the first update information received by Step 710 may comprise at least a magnitude of at least a portion of a first gradient determined using the first plurality of training examples, for example by the first external system. In one example, the second update information received by Step 730 may comprise at least a magnitude of at least a portion of a second gradient determined using the second plurality of training examples, for example by the second external system. In one example, the third update information received by Step 830 may comprise at least a magnitude of at least a portion of a third gradient determined using the third plurality of training examples, for example by the first external system. In one example, the second update information received by Step 850 may comprise at least a magnitude of at least a portion of a fourth gradient determined using the fourth plurality of training examples, for example by the second external system. In some examples, Step 750 may comprise using the information related to the distribution of the first plurality of training examples and the information related to the distribution of the second plurality of training examples to calculate an aggregate of the magnitude of the at least a portion of the first gradient determined using the first plurality of training examples and the magnitude of at least a portion of a second gradient determined using the second plurality of training examples. For example, Step 750 may calculate the aggregate of the magnitude of the at least a portion of the first gradient and the magnitude of at least a portion of a second gradient using a function of the information related to the distribution of the first plurality of training examples, the information related to the distribution of the second plurality of training examples, the magnitude of the at least a portion of the first gradient, and the magnitude of at least a portion of a second gradient. In another example, Step 750 may calculate the aggregate of the magnitude of the at least a portion of the first gradient and the magnitude of at least a portion of a second gradient using a function of the weight for the first update information (determined as described above), the weight for the second update information (determined as described above), the magnitude of the at least a portion of the first gradient, and the magnitude of at least a portion of a second gradient. In some examples, Step 870 may comprise using the information related to the distribution of the third plurality of training examples and the information related to the distribution of the fourth plurality of training examples to calculate an aggregate of the magnitude of the at least a portion of the third gradient determined using the third plurality of training examples and the magnitude of at least a portion of a fourth gradient determined using the fourth plurality of training examples. For example, Step 870 may calculate the aggregate of the magnitude of the at least a portion of the third gradient and the magnitude of at least a portion of a fourth gradient using a function of the information related to the distribution of the third plurality of training examples, the information related to the distribution of the fourth plurality of training examples, the magnitude of the at least a portion of the third gradient, and the magnitude of at least a portion of a fourth gradient. In another example, Step 870 may calculate the aggregate of the magnitude of the at least a portion of the third gradient and the magnitude of at least a portion of a fourth gradient using a function of the weight for the third update information (determined as described above), the weight for the fourth update information (determined as described above), the magnitude of the at least a portion of the third gradient, and the magnitude of at least a portion of a fourth gradient. In one example, Step 750 may use the calculated aggregate of the magnitude of the at least a portion of the first gradient and the magnitude of at least a portion of a second gradient to determine the global update to the inference model. In one example, Step 870 may use the calculated aggregate of the magnitude of the at least a portion of the third gradient and the magnitude of at least a portion of a fourth gradient to determine the second global update to the inference model. For example, the global update to the inference model (or a second global update to the inference model) may comprise a step in a size correlated to the magnitude of the calculated aggregate.

In some examples, Step 750 may use the information related to the distribution of the first plurality of training examples and the information related to the distribution of the second plurality of training examples to select one of the first update information and the second update information. For example, in response to a first combination of the information related to the distribution of the first plurality of training examples and the information related to the distribution of the second plurality of training examples, Step 750 may select the first update information, and in response to a second combination of the information related to the distribution of the first plurality of training examples and the information related to the distribution of the second plurality of training examples, Step 750 may select the second update information. Further, in some examples, Step 750 may use the selected one of the first update information and the second update information to determine the global update to the inference model. For example, the global update to the inference model may be the selected one of the first update information and the second update information, or a function of the selected one of the first update information and the second update information.

In some examples, Step 870 may use the information related to the distribution of the third plurality of training examples and the information related to the distribution of the fourth plurality of training examples to select one of the third update information and the fourth update information. For example, in response to a first combination of the information related to the distribution of the third plurality of training examples and the information related to the distribution of the fourth plurality of training examples, Step 870 may select the third update information, and in response to a second combination of the information related to the distribution of the third plurality of training examples and the information related to the distribution of the fourth plurality of training examples, Step 870 may select the fourth update information. Further, in some examples, Step 870 may use the selected one of the third update information and the fourth update information to determine the second global update to the inference model. For example, the second global update to the inference model may be the selected one of the third update information and the fourth update information, or a function of the selected one of the third update information and the fourth update information.

In some examples, in response to a first combination of the information related to the distribution of the first plurality of training examples and the information related to the distribution of the second plurality of training examples, Step 750 may determine a first value for the global update to the inference model, and in response to a second combination of the information related to the distribution of the first plurality of training examples and the information related to the distribution of the second plurality of training examples, Step 750 may determine a second value for the global update to the inference model.

In some examples, in response to a first combination of the information related to the distribution of the third plurality of training examples and the information related to the distribution of the fourth plurality of training examples, Step 870 may determine a first value for the second global update to the inference model, and in response to a second combination of the information related to the distribution of the third plurality of training examples and the information related to the distribution of the fourth plurality of training examples, Step 870 may determine a second value for the second global update to the inference model.

In some embodiments, the global update to the inference model determined by Step 750 and/or the second global update to the inference model determined by Step 870 may be provided to the first external system and/or to the second external system. In some examples, the global update to the inference model determined by Step 750 and/or the second global update to the inference model determined by Step 870 may be stored in a memory unit (such as memory units 210, shared memory modules 410, and so forth), for example within a shared memory accessible by the external system. In some examples, the global update to the inference model determined by Step 750 and/or the second global update to the inference model determined by Step 870 may be transmitted to the external system, for example using a communication device (such as communication modules 230), through a communication network (such as communication network 130), through an intermediate device (such as an intermediate processing device, a shared memory device), and so forth.

In some embodiments, the global update to the inference model determined by Step 750 may be used to update the inference model and obtain an updated inference model. Further, in some example, the updated inference model may be provided to the first external system and/or to the second external system. In some examples, the updated inference model may be stored in a memory unit (such as memory units 210, shared memory modules 410, and so forth), for example within a shared memory accessible by the external system. In some examples, the updated inference model may be transmitted to the external system, for example using a communication device (such as communication modules 230), through a communication network (such as communication network 130), through an intermediate device (such as an intermediate processing device, a shared memory device), and so forth.

In some embodiments, the second global update to the inference model determined by Step 870 may be used to update the inference model and obtain an updated inference model. Further, in some example, the updated inference model may be provided to the first external system and/or to the second external system. In some examples, the updated inference model may be stored in a memory unit (such as memory units 210, shared memory modules 410, and so forth), for example within a shared memory accessible by the external system. In some examples, the updated inference model may be transmitted to the external system, for example using a communication device (such as communication modules 230), through a communication network (such as communication network 130), through an intermediate device (such as an intermediate processing device, a shared memory device), and so forth.

In some embodiments, information related to a desired distribution of a plurality of training examples may be determined. For example, information related to a desired distribution of the first plurality of training examples of method 700 may be determined. In another example, information related to a desired distribution of the second plurality of training examples of method 700 may be determined. In yet another example, Step 810 may comprise determining information related to a desired distribution of the third plurality of training examples of method 800, for example based on a previously determined global update (such as the global update determined by Step 750). In an additional example, information related to a desired distribution of the fourth plurality of training examples of method 800 may be determined, for example based on a previously determined global update (such as the global update determined by Step 750). For example, in response to a first global update determined by Step 750, Step 810 may determine first information related to a desired distribution of the third plurality of training examples, and in response to a second global update determined by Step 750, Step 810 may determine second information related to a desired distribution of the third plurality of training examples, the second information may differ from the first information. In another example, in response to a first global update determined by Step 750, Step 810 may determine first information related to a desired distribution of the fourth plurality of training examples, and in response to a second global update determined by Step 750, Step 810 may determine second information related to a desired distribution of the fourth plurality of training examples, the second information may differ from the first information. In some examples, information related to a desired distribution of a plurality of training examples may be determined based on input received from a user. For example, in response to a first input from the user, first information related to the desired distribution of the plurality of training examples may be determined, and in response to a second input from a user, second information related to the desired distribution of the plurality of training examples may be determined, the second information may differ from the first information. In some examples, information related to a desired distribution of a plurality of training examples may be determined based on input captured by a sensor (such as an image or a video captured using an image sensor, audio data captured using an audio sensor, location data captured using a positioning sensor, motion data captured using a motion sensor, and so forth). For example, in response to a first captured input, first information related to the desired distribution of the plurality of training examples may be determined, and in response to a second captured input, second information related to the desired distribution of the plurality of training examples may be determined, the second information may differ from the first information. In some examples, information related to a desired distribution of a plurality of training examples may be determined based on an input provided to an inference model (for example, to a trained machine learning model, to a classification model, to a regression model, to a segmentation model, and so forth). For example, in response to a first provided input, first information related to the desired distribution of the plurality of training examples may be determined, and in response to a second provided input, second information related to the desired distribution of the plurality of training examples may be determined, the second information may differ from the first information. In some examples, information related to a desired distribution of a plurality of training examples may be determined based on an output generated by an inference model, for example in response to a particular input (for example, to a trained machine learning model, to a classification model, to a regression model, to a segmentation model, and so forth). For example, in response to a first generated output, first information related to the desired distribution of the plurality of training examples may be determined, and in response to a second generated output, second information related to the desired distribution of the plurality of training examples may be determined, the second information may differ from the first information.

In some embodiments, the determined information related to a desired distribution of a plurality of training examples may be provided to an external system to cause the external system to select the plurality of training examples according to the determined information related to the desired distribution of the plurality of training examples. While the determined information related to a desired distribution of a plurality of training examples may influence the selection of the plurality of training examples by the external system, the actual selected plurality of training examples may have different, substantially the same, or the same distribution as the desired distribution. For example, the determined information related to the desired distribution of the first plurality of training examples may be provided to the first external system to cause the first external system to select the first plurality of training examples according to the determined information related to the desired distribution of the first plurality of training examples. In another example, the determined information related to the desired distribution of the second plurality of training examples may be provided to the second external system to cause the second external system to select the second plurality of training examples according to the determined information related to the desired distribution of the second plurality of training examples. In yet another example, Step 820 may comprise providing the information related to the desired distribution of the third plurality of training examples and determined by Step 810 to the first external system to cause the first external system to select the third plurality of training examples according to the information related to the desired distribution of the third plurality of training examples determined by Step 810. In an additional example, the determined information related to the desired distribution of the fourth plurality of training examples may be provided to the second external system to cause the second external system to select the fourth plurality of training examples according to the determined information related to the desired distribution of the fourth plurality of training examples. In some examples, the determined information related to a desired distribution of a plurality of training examples may be stored in a memory unit (such as memory units 210, shared memory modules 410, and so forth), for example within a shared memory accessible by the external system. In some examples, the determined information related to a desired distribution of a plurality of training examples may be transmitted to the external system, for example using a communication device (such as communication modules 230), through a communication network (such as communication network 130), through an intermediate device (such as an intermediate processing device, a shared memory device), and so forth.

What is claimed is:

1. A non-transitory computer readable medium storing data and computer implementable instructions for carrying out a method for determining a global update to inference models using update information from a plurality of external systems, the method comprising:
receiving a first update information associated with an inference model, the first update information is based on an analysis of a first plurality of training examples by a first external system;
obtaining information related to the distribution of the first plurality of training examples;
receiving a second update information associated with the inference model, the second update information is based on an analysis of a second plurality of training examples accessible by a second external system;
obtaining information related to the distribution of the second plurality of training examples; and
using the first update information, the information related to the distribution of the first plurality of training examples, the second update information and the information related to the distribution of the second plurality of training examples to determine a global update to the inference model.

2. The non-transitory computer readable medium of claim 1, wherein the method further comprises:
determining information related to a desired distribution of the first plurality of training examples; and
providing the determined information related to the desired distribution of the first plurality of training examples to the first external system to cause the first external system to select the first plurality of training examples according to the determined information related to the desired distribution of the first plurality of training examples.

3. The non-transitory computer readable medium of claim 1, wherein the method further comprises:
determining, based on the global update, information related to a desired distribution of a third plurality of training examples;
providing the determined information related to the desired distribution of the third plurality of training examples to the first external system to cause the first external system to select the third plurality of training examples according to the determined information related to the desired distribution of the third plurality of training examples;
receiving a third update information associated with the inference model, the third update information is based on an analysis of the third plurality of training examples by the first external system;
obtaining information related to the distribution of the third plurality of training examples;
receiving a fourth update information associated with the inference model, the fourth update information is based on an analysis of a fourth plurality of training examples accessible by the second external system;
obtaining information related to the distribution of the fourth plurality of training examples; and
using the third update information, the information related to the distribution of the third plurality of training examples, the fourth update information and the information related to the distribution of the fourth plurality of training examples to determine a second global update to the inference model.

4. The non-transitory computer readable medium of claim 1, wherein the first plurality of training examples is accessible by the first external system and not accessible by the second external system, and wherein the second plurality of training examples is accessible by the second external system and not accessible by the first external system.

5. The non-transitory computer readable medium of claim 1, wherein the method further comprises:
using the information related to the distribution of the first plurality of training examples to determine a weight for the first update information;
using the information related to the distribution of the second plurality of training examples to determine a weight for the second update information; and
using the first update information, the weight for the first update information, the second update information and the weight for the second update information to determine the global update to the inference model.

6. The non-transitory computer readable medium of claim 1, wherein the method further comprises:
using the information related to the distribution of the first plurality of training examples and the information related to the distribution of the second plurality of training examples to determine a weight for the first update information and a weight for the second update information; and
using the first update information, the weight for the first update information, the second update information and the weight for the second update information to determine the global update to the inference model.

7. The non-transitory computer readable medium of claim 1, further comprising proving the global update to the first external system and to the second external system.

8. The non-transitory computer readable medium of claim 1, further comprising using the global update to update the inference model and obtain an updated inference model.

9. The non-transitory computer readable medium of claim 8, further comprising proving the updated inference model to the first external system and to the second external system.

10. The non-transitory computer readable medium of claim 1, wherein the first update information is insufficient to reconstruct any training example of the first plurality of training examples.

11. The non-transitory computer readable medium of claim 1, wherein the first update information is insufficient to reconstruct at least one training example of the first plurality of training examples.

12. The non-transitory computer readable medium of claim 1, wherein the first update information comprises at least a direction of at least a portion of a first gradient determined using the first plurality of training examples, and the second update information comprises at least a direction of at least a portion of a second gradient determined using the second plurality of training examples.

13. The non-transitory computer readable medium of claim 12, wherein the method further comprises:
using the information related to the distribution of the first plurality of training examples and the information related to the distribution of the second plurality of training examples to calculate an aggregate of the direction of the at least a portion of the first gradient determined using the first plurality of training examples and the direction of at least a portion of a second gradient determined using the second plurality of training examples; and
using the calculated aggregate to determine the global update to the inference model.

14. The non-transitory computer readable medium of claim 1, wherein the first update information comprises at least a magnitude of at least a portion of a first gradient determined using the first plurality of training examples, and the second update information comprises at least a magnitude of at least a portion of a second gradient determined using the second plurality of training examples.

15. The non-transitory computer readable medium of claim 14, wherein the method further comprises:
using the information related to the distribution of the first plurality of training examples and the information related to the distribution of the second plurality of training examples to calculate an aggregate of the magnitude of the at least a portion of the first gradient determined using the first plurality of training examples and the magnitude of at least a portion of a second gradient determined using the second plurality of training examples; and
using the calculated aggregate to determine the global update to the inference model.

16. The non-transitory computer readable medium of claim 1, wherein the method further comprises:
using the information related to the distribution of the first plurality of training examples and the information related to the distribution of the second plurality of training examples to select one of the first update information and the second update information; and
using the selected one of the first update information and the second update information to determine the global update to the inference model.

17. The non-transitory computer readable medium of claim 1, wherein the global update to the inference model is determined based on a gradient descent update of the inference model.

18. The non-transitory computer readable medium of claim 1, wherein the distribution of the first plurality of training examples differs from the distribution of the second plurality of training examples.

19. A system for determining a global update to inference models using update information from a plurality of external systems, the system comprising:
at least one processor configured to:
receive a first update information associated with an inference model, the first update information is based on an analysis of a first plurality of training examples by a first external system;
obtain information related to the distribution of the first plurality of training examples;
receive a second update information associated with the inference model, the second update information is based on an analysis of a second plurality of training examples accessible by a second external system;
obtain information related to the distribution of the second plurality of training examples; and
use the first update information, the information related to the distribution of the first plurality of training examples, the second update information and the information related to the distribution of the second plurality of training examples to determine a global update to the inference model.

20. A method for determining a global update to inference models using update information from a plurality of external systems, the method comprising:
receiving a first update information associated with an inference model, the first update information is based on an analysis of a first plurality of training examples by a first external system;
obtaining information related to the distribution of the first plurality of training examples;
receiving a second update information associated with the inference model, the second update information is based on an analysis of a second plurality of training examples accessible by a second external system;
obtaining information related to the distribution of the second plurality of training examples; and
using the first update information, the information related to the distribution of the first plurality of training examples, the second update information and the information related to the distribution of the second plurality of training examples to determine a global update to the inference model.
